(19) United States
(12) Patent Application Publication
(10) Pub. No.: US 2019/0022981 A1
(43) Pub. Date: Jan. 24, 2019

(54) VEHICLE LAMINATED GLAZING COMPRISING AN AMOLED SCREEN

(71) Applicant: SAINT-GOBAIN GLASS FRANCE, Courbevoie (FR)

(72) Inventors: Michael LABROT, Aachen (DE); Volkmar OFFERMANN, Eschweiler (DE); Bernhard REUL, Herzogenrath (DE)

(21) Appl. No.: 16/067,409

(22) PCT Filed: Dec. 22, 2016
(86) PCT No.: PCT/FR2016/053638

§ 371 Date: Jun. 29, 2018

(30) Foreign Application Priority Data
Dec. 31, 2015 (FR) 1563481

(51) Int. Cl. B32B 17/10; B60R 1/00

(52) U.S. Cl. CPC B32B 17/10036; B60R 1/001; B32B 17/10761; B32B 17/10541

(57) ABSTRACT

A laminated vehicle glazing includes within the laminate an AMOLED screen and a sensor. The AMOLED screen is in the clear window region or is masked by an external peripheral masking layer between the second main face of the first glazing and the rear face of the AMOLED screen and a connecting part is also optionally masked by the external masking layer between the second main face and its rear surface.

The invention relates to a laminated vehicle glazing and more particularly a laminated vehicle glazing integrating an AMOLED screen.

An ever greater number of intelligent windshields exist which deliver information to the driver.

Document WO2015041106 proposes in particular an automobile windshield comprising an AMOLED (Active Matrix Organic Light Emitting Diode) screen—between the internal faces of the two glazings, screen arranged peripherally and masked in the enameled boundary on face F2 that is to say the internal face of the outermost glazing. The horizontally positioned AMOLED screen is aimed at replacing the internal rear view mirror to see the rear of the vehicle—conventionally in the form of a mirror- and is preferentially situated in the central part along the top longitudinal edge of the windshield. It is coupled with a camera at the rear of the vehicle.

The aim of the invention is to improve this laminated vehicle glazing with AMOLED screen notably windshield with AMOLED screen.

For this purpose, the subject of the present invention is a laminated vehicle glazing notably windshield or lateral glazing of a vehicle notably a road vehicle, comprising:
a first glazing, preferably cambered, preferably of mineral glass, preferably tinted, notably gray or green, with a first main face termed F1 intended to be on the outside of the vehicle and a second opposite main face termed F2, glazing of thickness E1 preferably (especially in the road sector, for an automobile) of at most 2.5 mm, even of at most 2 mm—notably 1.9 mm, 1.8 mm, 1.6 mm and 1.4 mm- or even of at most 1.3 mm or of at most 1 mm,
a lamination interlayer of polymeric substance (clear, extraclear), preferably thermoplastic, on the face F2 side, of (total) thickness E2 preferably especially in the road sector, for an automobile) of at most 2.2 mm better of at most 2 mm, of at most 1.5 mm or even of at most 0.76 mm, for example composed of several plies for example 3 plies, notably set back from the lip of the second glazing (by at most 5 mm or even by at most 2 mm or by at most 1 mm)
a second glazing, preferably cambered (like the first glazing), preferably of mineral glass, with a third main face termed F3 on the lamination interlayer side and a fourth opposite main face termed F4, notably intended to be on the inside of the vehicle, optionally tinted (or clear and even with an electroconducting layer on face F3), of thickness E1 preferably less than E1, even of at most 2.2 mm (especially in the road sector, for an automobile)—notably 1.9 mm, 1.8 mm, 1.6 mm and 1.4 mm- or even of at most 1.3 mm or of at most 1 mm, the total thickness of the glazings E1+E′1 being preferably (especially in the road sector, for an automobile) strictly less than 4.4 mm, even than 3.7 mm, one at least—and better both—of the first and second glazings being made of glass, the other optionally of organic, polymeric substance such as a polycarbonate,
between the face F2 and the face F3, a first organic light-emitting diode-based viewing screen termed a flexible AMOLED screen 3, comprising a set of pixels, the first AMOLED screen comprising a (central) zone of dynamic information display, —the AMOLED screen comprising a first flexible support (glass polymeric substance, or indeed even metal) bearing organic light-emitting system(s) between two electrodes- and AMOLED screen of thickness E3 less than E2 preferably subcentimetric and even of at most 0.5 mm, AMOLED screen having a front main face oriented toward F3 and a rear main face oriented toward F2, —the AMOLED screen being covered by a non-zero thickness of lamination interlayer—and preferably within the lamination interlayer—therefore with a non-zero thickness E21 of lamination interlayer between the rear face and F2 and/or with a non-zero thickness E22 between the front face and F3, E2 corresponding to the thickness on the side of the AMOLED screen (notably E2>than E21+E22 and substantially equal to E3), the AMOLED screen is notably arranged peripherally,
preferably an electrical connection element 4 of the AMOLED screen, with a so-called connecting part between the face F2 and the face F3, of thickness E4 less than E2 and preferably subcentimetric, with a front surface on the face F3 side and a rear surface on the face F2 side, connecting part covered by a non-zero thickness of lamination interlayer and even preferably connecting part within the lamination interlayer (like the AMOLED screen) with a non-zero thickness E41 of lamination interlayer between the rear surface and the face F2 and with a non-zero thickness E42 (preferably identical to the thickness E3) between the front surface and the face F3).

The connecting part is linked (preferably permanent link) to the AMOLED screen and extends (directly) the AMOLED screen in the direction of the lip of the second glazing, and the flexible electrical connection element extending outside of the lip of the second glazing (via a so-called exterior part).

The connection element in particular is for the power supply and (preferably)/or transporting data signals (simultaneously or sequentially) in particular electrical connection element comprising one or more power supply tracks (or “supply lines”) and/or one or more tracks for the data signals (or “data lines”), and electronic components (optionally in particular in the connecting part).

The laminated vehicle glazing according to the invention (preferably road vehicle and even automobile windshield) furthermore comprises between the face F2 and the face F3 a first sensor, of thickness E6 less than E2, covered by a non-zero thickness E61 of lamination interlayer, optionally within the lamination interlayer, the first sensor being arranged according to the following configurations:

(a) between the face F2 and the rear face and/or the rear surface (at the periphery or behind the display zone)

(b) offset from the AMOLED screen and in proximity to the AMOLED screen or on a periphery of the AMOLED screen on the front face side,

(c) offset from the connecting part and in proximity to the connecting part or on the connecting part on the front face side.

The (transparent) AMOLED screen is furthermore in the clear window region or the AMOLED screen is masked by an, opaque, so-called external peripheral masking layer between the face F2 and the rear face of the AMOLED screen (preferably on face F2 and an enamel layer) and the connecting part is also optionally masked by the external masking layer (even when the AMOLED screen is in the clear window region, the connecting part can preferably be masked by the external masking layer).

Currently in automobile windshields, the sensors are arranged on face F4 in the zone of the conventional rear viewer in the form of a mirror, in a central position of the upper longitudinal edge. The sensors are masked from the interior by a housing on face F4, or concealed in the trim of the vehicle or else masked by an enamel added on face F4.

According to the invention, the first sensor (and one or more other sensors) is(are) arranged between the two glazings in proximity to or on the AMOLED screen. The first sensor is no longer projecting, and is thus protected and can be in interaction with the AMOLED screen.

The invention applies equally well when:
the AMOLED screen is in the clear window region and the connecting part is peripheral (notably opaque or slightly transparent and preferably masked from the exterior and/or the interior) or absent (the connection element being absent from the laminate, possibly being “wireless”)
the AMOLED screen and the connecting part are peripheral (notably opaque or slightly transparent, preferably masked from the exterior).

The AMOLED screen (like the optional electrical connection element) is preferably within lamination for better mechanical resilience. Thus, the lamination interlayer is then present at the front and at the rear of the AMOLED screen (like the optional connection element) this being advantageous with respect to a dissymmetric solution in which the AMOLED screen (like the optional connection element) is added (against or fixed by double-sided adhesive or glue or contact by adhesion) to the face F2 or the face F3.

For road vehicle windshields in particular, the glazings are preferably cambered and even in two directions, and preferably with two mineral glass glazings and even with a PVB lamination interlayer. In this case, the flexible AMOLED screen adapts to the curvatures like the optional connecting part (and the first sensor on flexible film). Preferably the laminated glazing forms a windshield of a road vehicle such as an automobile, a truck, with the first and second mineral glass glazings cambered and even a PVB lamination interlayer and an AMOLED screen within the lamination (just like the connecting part).

According to configuration a) the AMOLED screen can serve as electromagnetic shielding of the first sensor for the waves coming from the interior of the vehicle. If it is opaque or slightly transparent, the AMOLED screen also serves to mask from the interior the first sensor. A masking housing for the sensor is not necessary on face F4. The opaque or slightly transparent AMOLED screen is preferably dark, black in the off state. The first sensor thus masked can be non-transparent (opaque, reflecting etc), this being the simplest, or be transparent and even quasi-invisible (so as to be in the clear window region). Quasi-invisible transparent sensors exist, but to produce a sufficiently transparent sensor may, however, be constraining or impossible for certain types of sensors. Thus, certain sensors with wires are miniaturized or opacified to reduce their visibility but fine wires may remain visible and impair the transparency of the laminated vehicle glazing. Certain sensors with transparent layers may also induce optical distortions notably at the boundary between zone with layer and zone without layer.

According to one of the configurations a) or b) or c) the AMOLED screen or the connecting part can serve as support of the first sensor. They can be added during post fabrication or provided during fabrication of AMOLED screen or connecting part.

The first sensor can be on the perimeter of the AMOLED screen (in the same plane or on face F2 or F3 or within the lamination) and/or of the connecting part (in the same plane on face F2 or F3 or within the lamination), spaced apart or adjoining the rim of the AMOLED screen or of the connecting part or even sharing one and the same support. Thus the first sensor can be integrated in the AMOLED and/or in the connecting part.

In b) or c) the first sensor can be on face F3 or F4 in the display zone if transparent or in the vicinity, or indeed even in a zone intended to be masked by a housing or the trim of the vehicle.

The exterior part of the connecting element can also comprise a sensor useful to the glazing (windshield etc), opposite the lip or face F4 side.

The AMOLED screen can be opaque or transparent. The transparent AMOLED screen (in the clear window region in a peripheral zone or otherwise) is preferably defined by a luminous transmission (LT) of the zone of the laminated glazing comprising it at least equal to 70%.

The less transparent AMOLED screen (intended always to be peripheral) is preferably defined by a luminous transmission (LT) of the zone of the laminated glazing comprising it of less than 20% or even than 10%.

An opaque AMOLED screen can be defined as having a zero LT (for example by addition of a layer or paint—metallic . . . —at the rear of the carrier substrate of the AMOLED system).

In a first embodiment, the AMOLED screen is opaque or transparent with a luminous transmission LT of less than 10% and even less than 5% and/or the connecting part is opaque or of luminous transmission LT of less than 10% and even than 5%. And:
in configuration a), the first sensor is masked from the exterior by said external masking layer, or opposite a detection area corresponding to an opening of the external masking layer
or in configuration b) or c), the first sensor is masked from the exterior by (an opaque element of) the AMOLED screen or by the connecting part and/or by the external masking layer.

In the case of a windshield in particular (notably road vehicle), this AMOLED screen—preferably in configuration a)—can be arranged peripherally and preferably in the central zone of the upper longitudinal edge in particular in a zone where the width of the external masking layer is of larger width L1 than its width L0 on the drivers and/or copilot's side.

This makes it possible to arrange an AMOLED screen (opaque or slightly transparent) of larger size notably with a larger height H3 (dimension along the vertical). The AMOLED screen can also be more toward the center (edge as close as possible to the boundary).

It is also possible to adjust the width W3 or the width H3 so that the first sensor is alongside the AMOLED screen in a zone of the external masking layer (with opening) or without external masking layer (but with an accepted low LT).

In configuration b), the AMOLED screen can mask the first sensor from the exterior by any means: layer (deposition or add-on film) on the rear face, opaque support, dielectric protective substance (resin, varnish; film etc) on the rear face or at the front periphery of the display zone. In configuration b)′, the connecting part can mask the first sensor from the exterior by any means: layer (deposition or add-on film) on the rear face, opaque support, dielectric protective substance (resin, varnish; film etc) on the rear face or at the front.

In configuration a), the AMOLED screen can mask the first sensor from the interior by any means: layer (deposition or add-on film) on the rear face, electrode, opaque support, dielectric protective substance (resin, varnish; film etc) on the rear face or at the front periphery of the display zone. In configuration a), the connecting part can mask the first sensor from the interior by any means: layer (deposition or add-on film) on the rear face, electrode, opaque support, dielectric protective substance (resin, varnish; film etc) on the rear face or at the front periphery of the display zone.

Alternatively, the AMOLED screen is in the clear window region (peripheral zone without rear masking or restricted zone B) and:
in configuration a), in the zone with the first sensor and the AMOLED screen or the connecting part, the luminous transmission of the laminated glazing is at least 70%,
and in configuration b) (or c)) in the zone with the first sensor and optionally the AMOLED screen, the luminous transmission of the laminated glazing is at least 70%. The first sensor is then also transparent even quasi-invisible (so as to be in the clear window region).

Preferably, the first sensor is in a sweep zone of one or more windshield wipers of the windshield of a road vehicle such as an automobile, a truck.

Of course provision may be made for a plurality of first sensors in (a) and/or (b) and/or c), alongside one another, on the first glazing, or even directly on the AMOLED screen or the connecting part, on one and the same support or otherwise, such as a polymeric support or indeed a glass plate.

The first sensor is preferably chosen from among one at least of the following sensors:
a rain detector (preferably in the windshield wiper zone) typically from 100 mm² to 600 mm² in size
a camera in the visible (anti-collision detector, detector of object or person in motion or otherwise) or infrared camera (night vision, anti-collision detector, detector of object or of person in motion or otherwise, for example of trapezoidal shape, and even several cameras of the same type for stereoscopic vision
one or more (typically 6) light sensors, such as a photodiode, typically from 1.2×1.4 mm² to 1.4×1.8 mm² in size
   a thermometer, thermocouple typically a wire 0.5 mm or less in thickness
   an alarm sensor (detection of an integrity defect of the glazing etc), typically of conducting wire size from 12 to 150 μms in diameter or through an electroconducting layer (on face F2 or F3)
   a mist detector linked to a heating element (resistive etc)—such as a demist, anti-condensation, anti-freeze-, typically 100-200 cm² in size, for example integrated into a rain detector
   a sensor forming an antenna, for example a conducting wire typically from 12 μm to 0.5 mm in thickness, for receiving and/or transmitting electromagnetic waves (radio, TV, notably local communication network such as BLUETOOTH, WIFI, WLAN), notably within the lamination or embedded in a polymeric substance (film etc)
   an acoustic sensor (based on a piezoelectric element)
   an ultrasound signal detector preferably on the face F2, (for example based on a piezoelectric element)
   a diagnosis sensor (defects of the laminated vehicle glazing notably windshield or lateral glazing) based on an electroconducting layer (uninterrupted surface)
   a control detector (windshield wiper, etc), for example IR control or voice control (piezoelectric).

In one embodiment, the first sensor or another sensor is a coupling sensor, coupled functionally to the AMOLED screen controlling at least one display parameter and/or image data and optionally on face F4.

The coupling sensor can be arranged according to configurations a), b) or c) or else away from laminated glass in proximity to the windshield (dashboard, front of the bodywork).

The following may be cited as a display parameter:
brightness, contrast, sound volume, zoom, on/off in case of alerts (road accidents, tailbacks, diversion, bad weather, police message, . . . ), and/or on/off in case of telephone call
image data: selection of the information channel, of the type of information: safety, environmental, geographical . . . .

The coupling sensor is preferably chosen from among one at least of the following sensors:
a camera in the visible or infrared camera (night vision, anti-collision detector, detector of object or of person in motion or otherwise ahead), the display screen allowing us to see the front.
a mist detector linked to a heating element notably on face F4, to properly see the AMOLED screen
a sensor forming an antenna for receiving and/or transmitting electromagnetic waves (radio, TV . . . , notably local communication network such as BLUETOOTH, WIFI, WLAN) for the AMOLED screen
a voice control detector for the AMOLED screen (transducer etc).

Naturally, it is possible to have a plurality of coupling sensors.

The term sensor is taken in the broad sense can be one or more conducting layers or even any type of electronic or indeed optoelectronic component, photodetectors, or even electromechanical: piezoelectric modules, MEMS (for Microelectromechanical structure). These components can take any form, for example surface mounted (known by the name “SMC”) or any other type of package or in the form of chips. It is possible to use any type of bearer support to carry the sensor for example electrical insulator: PET polyethylene terephthalate, polytetrafluoroethylene (teflon), epoxy, glass fibers, glass wool, polyester, cotton paper or FR-1, -2, -3, -4, -5, -6, CEM-1, -2, -3, -4, -5 and optionally with a metal layer forming a thermal dissipater.

The sensor support can be transparent especially if it is not masked as can the sensor power supply conductors. This involves tracks of suitable width, of transparent electroconducting substance: stack of thin silvered layers or else of transparent conducting oxide layer (ITO, ATO etc). This support can be a printed circuit board obtained by selective attack of a metallic conductor (copper etc)

The first sensor (or any sensor) can itself be (as can the power supply conductors) on a (thin) flexible support distinct or not from the connecting part, in the same plane or not as said connecting part.

Various types of sensor exist: capacitive, resistive, inductive.

Naturally, it is also preferred to mask the electrical connections and power supplies of the first sensor.

Naturally a camera can benefit from a heater sensor to avoid misting.

The antenna signals (radiofrequency, microwave frequency, HF, UHF) are for example for remote-toll-payment or arise from a local communication network such as BLUETOOTH, WIFI, WLAN.

The capacitive element operates with a signal analysis and processing unit such as an electronic circuit or indeed a chip of qq mm² at most, also masked from the exterior and in the vicinity of the first sensor (coupling sensor). Any parasitic capacitance is avoided. For example a sensor comprises three electrodes used for so-called differential measurements or else with at least two electrodes, each electrode and linked to a conductor supplying them (of small dimensions with respect to the electrodes), conductors for example spaced apart by at most 1 mm. Conductor and electrode can be made of the same material for example with a metallic conducting film of sheet resistance of at most 10 ohms/square or indeed even of at most 5 ohms/square.

For example a sensor comprises two concentric electrodes, each comprising two sectors of annular general shape, linked respectively to conductors.

The electrodes and their conductors are also made in a cut conducting layer. The conductors are linked to a processing assembly. The conductors between the annular electrodes and the junction ends joining with the signal supply and processing device, are a distance d apart which is of the order of the dimension of the sensor. The mode of operation is that described previously. The frequency of analysis of the charge of the electrodes is fixed at 33 Hz. To further improve the “signal/noise” ratio a peripheral strip of the conducting layer is earthed.

The conducting elements forming the sensor and the optional support are for example inserted into the glazing in a zone without internal and/or external masking. They are then of essentially transparent materials so as not to significantly interrupt the visual aspect of the glazing. In a preferred manner the support and the sensor, which is constructed in conducting layers applied to this support, are chosen so that they exhibit a luminous transmission determined according to the standard EN 410 which is not less than 70% and preferably not less than 80%.

The supports used for the in particular capacitive sensors need to be inserted easily into the glazing. They are preferably of the smallest possible thickness that their operation permits. If the support comprises only the sensor, a flexible film for example of polyethylene terephthalate termed PET, coated with the conducting layers can be used. In this case the thickness can be particularly small, of a few hundredths of a millimeter. The insertion of a support is done in a favored manner from an edge of the glazing.

The combining of different functional assemblies in one and the same glazing, all of them powered electrically, inevitably gives rise to fields which may disturb the operation of the capacitive sensor. To eliminate or at least minimize these parasitic influences, the capacitive sensor is advantageously constructed so as to effect enhanced discrimination of the signals emitted by the sensor. For this purpose the sensor comprises a set of two electrodes situated in the neighborhood one of the other. In order that the installing of multiple elements, notably conductors linking the sensor to a processing unit situated outside of the glazing, does not complicate the structure and the assembling of the glazing, these conductors are advantageously made in the same layer as that of the electrodes of the capacitive sensor, and hence also offer the same transparency if necessary. Optionally other conductors can also be used, notably wires of very small diameter and which are therefore almost indiscernible.

The transparent electrical conducting products which can be used according to the invention to constitute the sensor are well known in the glassmaking field. They consist of sufficiently thin layers of conducting oxides, or of metallic layers the latter disposed in sets of dielectric protective layers.

Featuring among the most conducting oxide layers (TCO) are, in particular, layers based on indium oxide doped with tin oxide (ITO). These layers, at thicknesses meeting the transparency condition, make it possible to attain resistances of less than 50Ω/α and preferably of less than 30Ω/α and particularly less than 20Ω/α. The electrical resistance of the layers is necessarily dependent on their thickness. An increase in the thickness makes it possible to reduce the resistance but has to cope with the necessity to preserve good transparency. For the layers of ITO type an acceptable absorption level corresponds to layers whose thickness does not exceed 300 nm, and preferably 200 nm.

All the constituents included in the cambered glazings must be able to withstand these curvatures, hence the necessity to use sufficiently flexible supports for the sensors. Moreover when the supports for the sensors exhibit a non-negligible thickness of for example at least 0.15 mm and even of at least 0.2 mm, it is preferable, in order to facilitate assembly, to dispose these supports in a corresponding reserve made in a lamination interlayer sheet of like thickness, thus constituting a sort of frame for the support.

In one embodiment, the first sensor (and its power supply) can be an add-on piece, notably glued, stuck on the rear face and/or the rear surface or even on the front surface or else on the face F2
for example one or more electroconducting wires (embedded or not in a resin)
or else a conducting element (electroconducting layer) on a flexible polymeric support (such as PET, PC etc).

In one embodiment, the first sensor (and its power supply) is on the face F2, on the external masking layer on face F2 or in the detection area (opening(s) of the external masking layer).

In particular, the external masking layer, preferably of enamel, is on face F2 and notably the first sensor is made of electroconducting enamel on the first masking enamel and even masked by the internal masking layer. In particular, the internal masking layer, preferably of enamel, is on face F3 and notably the first sensor is made of electroconducting enamel on the this layer.

In a second embodiment, the first sensor (and its power supply) comprises a conducting layer at the front or the rear of the AMOLED screen or of the connecting part, or else a conducting layer on the face F2 or face F3.

The first sensor may be liable to create a detrimental local pressure on the rear face (or front face) of the AMOLED screen, any variation of thickness even very small often creating deformations visible in reflection, for example on account of its overly large thickness E6 (maximum) and its design (use of add-on piece(s) rather than layers), provision may be made:
for adapting the thickness of the first flexible support of the AMOLED screen
for a compensation in thickness over the entire surface opposite on either side of the sensor or sensors
or for offsetting the first sensor away from the AMOLED zone.

In one embodiment, the laminated vehicle glazing comprises on face F2 or on face F3 or F4 a transparent electroconducting layer forming an antenna:
if on face F3 opposite the front face
or if on face F3 absent from the zone opposite the front face, notably in a zone peripheral to the information display zone and even to the AMOLED screen and to the external masking layer.

It is possible to have a zone on face F4 which is a sensor formed from a transparent electroconducting layer made for example of conducting transparent oxide (ITO for example alone or in a stack). For example the sensor is an antenna element (for signals coming from the interior and/or from the exterior).

This local layer can be heating and antimist opposite the display zone.

This layer can also be peripheral and carry a sensor in a zone covered by a housing or under the trim.

According to the invention the sensor can be masked or in a vision zone and be associated with one or more electronic components (amplifier, decoder, power supply cable etc) preferably away from the vision zone (housing on face F4 or under the trim or along the rim of the glazing or in the dashboard).

Preferably, the external masking layer is made of enamel and on face F2 behind the AMOLED screen and the optional other AMOLED screen or screens.

In the off state, the AMOLED screen zone might not be distinguishable from the masking zone further to the rear. Provision may be made to adapt the color of the external masking layer (enamel notably, on face F2) accordingly.

In one embodiment, the AMOLED screen is transparent and in the clear window region or in that the (transparent or opaque) AMOLED screen is masked by a so-called external masking layer between the rear face of the AMOLED screen and the face F2 (and/or the electrical connection element is masked from the exterior notably by a so-called external masking layer between the rear surface and the face F2 and the technical edge or edges of the AMOLED screen as well as the connection element are masked from the interior by a so-called internal masking layer on face F3 or F4.

In one embodiment, the laminated glazing comprises a plurality of AMOLED screens, notably at the periphery of one and the same longitudinal or lateral edge.

In a preferred embodiment, the AMOLED screen covers at most the entire peripheral zone visible by the driver (or copilot if AMOLED screen on the latter's side) in the (automotive) road vehicle windshield up to the edge of the transparent central vision zone and more precisely:
up to the upper edge of the transparent central vision zone if the AMOLED screen is arranged at the top in a horizontal manner on the drivers side (or copilot's side if AMOLED screen on the latter's side) along the drivers (or passengers) side upper longitudinal edge
up to the lower edge of the transparent central vision zone if the AMOLED screen is arranged at the bottom in a horizontal manner on the drivers side (or copilot's side if AMOLED screen on the latter's side) along the drivers (or passengers) side lower longitudinal edge
up to the upper edge of the transparent central vision zone if the AMOLED screen is arranged at the top in a horizontal or vertical manner in the central zone of the upper longitudinal edge
up to the left edge of the transparent central vision zone (respectively right) if the AMOLED screen is arranged in a vertical manner on the left preferably drivers side (respectively right preferably copilot's side) along the left lateral edge, preferably in the bottom part (lower half of the lateral edge) so as to be wider.

The same holds for said other AMOLED screen or screens—if opaque or slightly transparent preferably masked by the external masking layer, preferably on face F2—.

The upper, lower, lateral (left and right) edges (or limits) of the transparent central vision zone are notably defined by a regulating standard. For example for an automotive road vehicle windshield, this involves the restricted zone B defined according to European standard UN-ECE R43 annex 18, in particular page 133 and § 2.4. The upper limit of the transparent central vision zone is preferably defined on the basis of an angle between the horizontal and 7° from a reference point (the drivers eye, eye at the height Z with respect to the seat of the vehicle with Z=665 mm for a tall driver or Z=589 mm for a short driver.

From the edge concerned of the laminated glazing notably road vehicle windshield, the following distances are defined:
h1 distance between the upper edge and the upper limit of the peripheral zone of vision of the driver (or of the copilot if AMOLED screen on the latter's side) in the vehicle, preferably of at least 15 mm and even of at least 50 or 90 mm
h′1 distance between the lower edge and the lower limit of the peripheral zone of vision of the driver (or of the copilot if AMOLED screen on the latter's side) in the vehicle preferably of at least 40 mm and even of at least 100 or 200 mm
h4 distance between the lateral (left or right) edge and the lateral limit of the peripheral zone of vision of the driver (or of the copilot if AMOLED screen on the latter's side) in the vehicle preferably of at least 15 mm and even of at least 20 or 40 mm.

Away from the zone of the AMOLED screen (and/or of said other AMOLED screens) it is possible to form an external peripheral masking layer (on face F2) like enamel, from the lip up to h1, h′1, h4 while protruding beyond for example the (predetermined) vision zone by at most 2 cm as conventionally.

According to the invention, it is possible to increase in a way the width of the external masking layer so as to mask the AMOLED screen (and said other AMOLED screen or screens) and at the maximum up to the limits of the central transparency zone. The external masking is therefore possible from the limit of the restricted vision zone B up to the edge of the (first) glazing. As a function of the edge concerned of the laminated glazing notably road vehicle windshield, the following distances are defined:
h2 distance between the upper edge and the upper limit of the central zone of transparency on the driver's side (or copilot's side if AMOLED screen on the latter's side), preferably of at least 120 mm and even of more than 150 mm or 200 mm or 220 mm, the AMOLED screen being above said upper limit and even the optional other AMOLED screen(s),
h′2 distance between the lower edge and the lower limit of the central transparency zone on the drivers side (or copilot's side if AMOLED screen on the latter's side) preferably of at least 120 mm and even of more than 150 mm or 300 mm and the AMOLED screen being below said lower limit and preferably the optional other AMOLED screen(s),
Hₐ distance between the upper edge and the upper limit of the central transparency zone in the central part (for AMOLED screen in central position), preferably of at least 180 mm and even of at least 250 mm or 300 mm and the AMOLED screen being between the edge and the upper limit and preferably the optional other AMOLED screen(s),
h5 distance between the lateral (left or right) edge and the lateral limit of the central zone of transparency on the drivers side (or copilot's side if AMOLED screen on the latter's side) preferably of at least 80 mm and even of more than 120 or 150 mm, and the AMOLED screen being between the lateral edge and said lateral limit and preferably the optional other AMOLED screen(s).

The height h6 of the restricted zone B in the top position (between the potentially opaque zone and the most central zone A) can be from 60 mm to 90 mm. It can serve for a (fairly) transparent AMOLED screen (which may ascend into the potentially opaque zone). Preferably the external masking layer is higher than the AMOLED screen.

The height h′6 of the restricted zone B in the bottom position (between the potentially opaque zone and the central-most zone A) can be between 60 mm and 90 mm. It can serve for a (fairly) transparent AMOLED screen (which may descend into the potentially opaque zone). Preferably the external masking layer is lower than the AMOLED screen.

The external masking layer zone is preferably at least as large as the surface of the AMOLED screen, preferably slightly larger:
for example by at least 5 mm on each side of the AMOLED screen
and/or for example by at least 5 mm under the most central edge (bottom edge if position at the top of the AMOLED screen, bottom edge if position at the bottom of the AMOLED screen).

The external masking layer can be a solid zone (flat patch) extended by a discontinuous zone in the form of a network of patterns (geometric patterns, round, square, rectangular shape etc) preferably in gradation in the direction of the center of the laminated glazing (windshield). The gradation can be at most 15 mm and even at most 10 mm and at least 3 or 5 mm in width. The gradation can be in the zone of the lower longitudinal edge of at most 30 mm and even of at most 25 mm and of at least 10 or 15 mm in width. Preferably the AMOLED screen is not behind the gradation but behind the solid zone. At the limit only the gradation can protrude beyond the AMOLED screen.

It is possible with several masking zones widened along a reference edge or distinct edges and even a widened masking zone therefore dedicated for each AMOLED screen.

The laminated glazing notably an (automotive) road vehicle windshield of rectangular shape can be:
of width (horizontal dimension) Lp of at least 1200 mm and of at most 1850 mm and preferably from 1350 to 1550 mm.
of height (vertical dimension) Hp of at least 800 mm and of at most 1400 mm and preferably from 950 to 1050 mm.

Preferably the AMOLED screen (in an automotive road vehicle windshield) is at least 80 mm by 120 mm.

Preferably the height H3 (and W3) of the AMOLED screen in an automotive road vehicle windshield is adjusted as a function of the standard in force.

Preferably the width W3 of the AMOLED screen in an automotive road vehicle windshield arranged horizontally in the top position (upper edge) is at least 100 mm and better at least 120 mm and even greater than 200 mm, than 350 mm, and even greater than or equal to 500 mm, notably or over the entire drivers side zone between a first visible lateral edge and the top central zone (and even all or part of the top central zone included) or the entire copilot's side zone between the second visible lateral edge and the top central zone (and even all or part of the top central zone included).

Preferably the height H3 of the AMOLED screen in an automotive road vehicle windshield arranged horizontally in the top position (upper edge) is at least 80 mm and better at least 100 mm.

Preferably the width W3 of the AMOLED screen in an automotive road vehicle windshield arranged horizontally in the bottom position (lower edge) is at least 100 mm and better at least 120 mm and even greater than 200 mm, than 350 mm and even greater than or equal to 500 mm, notably or over the entire driver's side zone between the visible lateral edge and a middle zone (and even all or part of the bottom central zone included) or the entire copilot's side zone between the second visible lateral edge and the bottom central zone (and even all or part of the bottom central zone included). Preferably the height H3 of the AMOLED screen in an automotive road vehicle windshield arranged horizontally in the bottom position (lower edge) is at least 80 mm and better at least 100 mm.

Preferably the width W3 of the AMOLED screen in an automotive road vehicle windshield arranged vertically in the top position (upper edge) in the central zone is at least 100 mm and better from at least 120 mm to 280 mm or even 300 mm.

Preferably the height H3 of the AMOLED screen in an automotive road vehicle windshield arranged vertically in the top position (upper edge) in the central zone is at least 80 mm and better at least 100 mm and even from at least 150 mm and up to 200 mm.

The connection element can be “wireless”. A flexible (flat) connector according to the invention is however preferred for the transport of the power signals and/or data signals to one or more induction-based or capacitive etc. wireless connectors. The electrical connection element preferably of submicronic thickness E4 substantially equal to E2 and of thickness E′4 less than E4 beyond the lip of the second glazing, is preferably curved and against or better fixed by gluing on face F4 without stretching as far as the display zone. The exterior part is preferably curved, stretches from the side of the face F4 and is against or better fixed by gluing on face F4 without stretching as far as the display zone.

The connection element is advantageously partially covered or shrouded, if appropriate, with any material so as to increase the thickness thereof to a value essentially equal to that of the AMOLED screen notably up to the edge of the laminated glazing.

The connection element is preferably a flexible printed circuit (“fpc”). The connection element is preferably capable of addressing a large number of pixels.

The width of the flexible electrical connection element (notably the connecting part) can be less than or substantially equal to that of the AMOLED screen, typically 50 mm in width for AMOLED widths (horizontal dimension) of at least 100 mm and even more than 150 mm. Large (wide) screens can have several flexible electrical connection elements preferably on one and the same edge of the AMOLED screen.

The distance between the termination of the electrical connection element and the lip of the second glazing is sufficiently large for this termination to be accessible during mounting or dismantling. The total length (unfolded) is adjusted for the connection element to be folded around the second glazing and fixed on face F4. From the exit of the interior glass, a distance of 20 to 150 mm is preferably envisaged.

In one embodiment, the electrical connection element (notably the connecting part) comprises:
a flexible support preferably polymeric, transparent or otherwise (such as a PET etc) with first front face and first rear face, wires or preferably conducting tracks on the front or rear side,
optionally electronic components such as transistors,
the wires or tracks (and electronic components) being covered by an electrically insulating substance, such as a layer of resin or varnish (liquid deposition etc) or a transparent or non-transparent protective film (PET, polyimide etc) for example adhesive-coated.

The connecting part can be linked by any known means to the AMOLED screen: clipping, plug-in. Preferably the connecting part and the AMOLED screen are linked by one or more permanent (solid) links. A link between the connecting part and the AMOLED screen can be made on a technical edge of the AMOLED screen.

Preferably, a polyethylene terephthalate PET, a polyimide, a polyester, a poly(vinyl chloride) PVC, a polycarbonate, polyetheretherketone (PEEK), an acrylate, is chosen as flexible polymeric film, doing so for one at least of the following elements:
the AMOLED screen (substrate, rear or front protective film: facade film etc),
the electrical connection element notably the connecting part (substrate, rear or front protective film).

The second glazing preferably comprises a local notch. The connection element exits the lip of the second glazing via the notch of width preferably at least the width of the connection element and preferably at most the width of the AMOLED screen (not including the radii of the fitting).

The dimensions of the notch are therefore adapted:
width of the notch greater than or equal to that of the connection element;
depth of the notch greater than or equal to the thickness of the connection element so as to avoid it being visible from the outside in a case when the edge is evident.

In practice the depth of the notch is preferably from 1.5 mm to 3 or even to 2 mm.

The notch zone is preferably (substantially) devoid of lamination interlayer.

The lamination interlayer of polymeric substance is chosen from among polyvinylbutyral, ethylene-vinyl acetate, ionomer polyurethane or resin, alone or in mixtures of several varieties of one of them and/or of several of them; the term “varieties” refers here to variations of the amount of plasticizer, of branchings/linearity, average molecular weight of the molecules . . . .

To ensure good water-tightness, it surrounds and is in contact with the AMOLED screen (rim and front and rear face) indeed even of the electrical connection element of flat connector type.

The lamination interlayer can itself be made of polyvinylbutyral (PVB), polyurethane (PU), ethylene/vinyl acetate copolymer (EVA), formed from one or more films, having for example a thickness of between 0.2 mm and 1.1 mm.

The surface of the lamination interlayer can be smaller than the surface of the laminated glazing, for example leaving a groove (frame-like or banner-like), which is free and therefore unlaminated.

The first glazing like the second glazing may be parallelepipedal, with rectangular, square main faces or sheets or even of any other shape (round, oval, polygonal).

The first and/or second glazing can (according to the esthetic result, the desired optical effect) be a clear glass (of luminous transmission LT greater than or equal to 90% for a thickness of 4 mm), for example a soda-lime standard composition glass such as Planilux® from the company Saint-Gobain Glass, or extra-clear glass (LT greater than or equal to 91.5% for a thickness of 4 mm), for example a soda-lime-silica glass with less than 0.05% of Fe III or of Fe₂O₃ such as Diamant® glass from Saint-Gobain Glass, or Optiwhite® glass from Pilkington, or B270® from Schott, or another composition described in document WO04/025334.

The glass of the first and/or second glazing can be neutral (no coloration), or (slightly) tinted notably gray or green, such as the TSA glass from the company Saint-Gobain Glass. The glass of the first and/or second glazing can have undergone a chemical or thermal treatment of the hardening, annealing type or a tempering (for better mechanical strength notably) or be semi-tempered.

The luminous transmission LT can be measured according to ISO standard 9050:2003 using the illuminant D65, and is the total transmission (notably integrated in the visible region and weighted by the sensitivity curve of the human eye), taking account both of direct transmission and of possible diffuse transmission, the measurement being made for example with the aid of a spectrophotometer furnished with an integrating sphere, the measurement at a given thickness thereafter being converted if appropriate to the reference thickness of 4 mm according to ISO standard 9050:2003.

For a laminated vehicle glazing notably windshield or lateral glazing, the LT can preferably be at least 70% and even at least 75% or 80%.

In one embodiment the first glazing is made of mineral glass and the second glazing is made of organic glass (such as PC, PMMA, cyclo-olefin copolymer (COC) or else polyethylene terephthalate (PET) optionally protected by a coating (on face F4).

The exterior glazing can comprise functional thin layers on one or the other of its faces F1 and F2 or else both: it is possible to cite a photocatalytic self-cleaning or hydrophobic layer on face F1.

Preferably the laminated glazing forms a windshield of a road vehicle such as an automobile, a truck, with the first and second glazing cambered and even a PVB lamination interlayer. The camber of the first and second glazings (windshield) can be in one or more directions for example as described in document WO2010136702.

The AMOLED screen can preferably have a thickness of at most 0.8 mm, preferably at most equal to 0.7 mm, and in a particularly preferred manner at most equal to 0.6 mm and even of at least 0.15 mm.

The AMOLED screen preferably comprises a flexible support (polymeric, glass or indeed a metal) bearing a so-called lower electrode (often the anode) of an organic light-emitting system and an upper electrode, while including a matrix of thin-film transistors (TFT). Other functional elements or layers are possible notably:
between the support and the lower electrode and in the form of a deposition or film: barrier layer (against oxygen, moisture etc),
on the upper electrode and in the form of a deposition or film: protective layer (against oxygen, moisture etc), for example a deposition (varnish, shrouding, resin etc) and/or facade film (transparent polymeric film: PET etc).

More precisely the pixel preferably comprises side by side two or three of the following systems:
an organic light-emitting system emitting in the red termed “R”,
an organic light-emitting system emitting in the green termed “G”,
an organic light-emitting system emitting in the blue termed “B”,
an organic light-emitting system emitting in the white termed “W”;

in particular RGB, RWB, WBG, RWB, W, BG.

The number of pixels is at least 64×128. The emission is of top emitting type (emission away from the substrate). Front face is intended to mean the viewing face.

Provision may be made for means for modulating the power of the AMOLED screen according to at least two configurations: a configuration for nighttime vision, in which the power of the AMOLED screen is adjusted so that the luminance typically lies between about 10 and about 400 Cd/m² and a configuration for daytime vision, in which the power of the AMOLED screen is adjusted so that the luminance typically lies between about 10 and about 500 Cd/m². In daytime vision, it is also possible to adjust the luminance of the AMOLED screen as a function of the exterior illumination.

All information can be displayed on the AMOLED screen (notably on a windshield): exterior and interior atmospheric conditions, vision of the rear environment, vision of the left and right lateral environment (as already indicated), information related to the driving conditions and signposts, technical information relating to the transport vehicle.

The AMOLED screen in particular can have one or more of the following functions (which can be aggregated):
central vision of the rear,
display of driving aid information, in particular alerts, detection of obstacles,
display of information (levels, operating state, state of wear, etc) on the characteristics of the vehicle (engine, wheels, brakes, headlights etc), in particular in case of alert (with a requested stop),
display of information on the exterior environment: weather, distance to a service station (to an electricity point etc), to a town, to a highway exit,
display of information on connectivity: access to the network (social network, Internet etc),
operation in telephone mode: display of the speaker, of a person (police, medical setting) in case of emergency and/or of accident or of a risk situation.

The AMOLED screen and/or another AMOLED screen can also act as copilot side TV, or as operation in telephone mode: display of the speaker, of a person (police, medical setting) in case of emergency and/or of accident or of a risk situation.

The AMOLED screen can display several images as in a television
main image (central vision of the rear etc)
inlaid image(s) (lateral vision of the vehicle etc).

The AMOLED screen is notably rectangular or square.

On the front face side, at least one peripheral band termed the technical edge of the AMOLED screen (distinct zone from the active zone, for display) can be masked by a so-called internal masking layer, preferably of enamel, on the face F3 or F4 or by a masking element (opaque layer, film) on the front face. And/or the front surface of the connection element (the connecting part) can be masked by a (same) so-called internal masking layer, preferably of enamel, on the face F3 or F4 or by a masking element (opaque film) on the front surface.

The internal masking layer is optionally a flat patch with an opening revealing the display zone and of width less than or equal to the width of the external masking layer. The internal masking layer can form not only:
a masking of the connecting part, opaque or slightly transparent,
as well as a masking of the technical edges of the AMOLED screen, seen from the interior side of the glazing, notably of the windshield,
and even, by protruding beyond the technical edge or edges, of the junction between the lamination interlayer and the AMOLED screen, which junction may comprise irregularities and flaws, (and even of the junction between the lamination interlayer and the connecting part).

The masking element can form part of a support film and/or protection such as polyethylene terephthalate (PET) of the AMOLED screen and of the connecting part.

The opaque film can be stuck to the whole of the AMOLED screen and of the connecting part immediately when premounted with a view to its storage, or else form part of a film which has been stuck to this premounted assembly, from which film can then optionally be removed an undesired part precut before assembling the windshield.

The masking element (opaque film etc) can form not only:
a masking of the connecting part, opaque or slightly transparent,
as well as a masking of the technical edges of the AMOLED screen, seen from the interior side of the windshield,
and even, by protruding beyond the technical edge or edges, of the junction between the lamination interlayer and the AMOLED screen, which junction may comprise irregularities and flaws, (and even of the junction between the lamination interlayer and the connecting part).

The opaque film can also be an opacified extension of the transparent polymer material covering the AMOLED screen, that is to say be an integral part thereof.

The opaque film can also alternatively or cumulatively be an extension of the polymer material covering the connecting part, that is to say be an integral part thereof.

The internal masking layer or the masking element (the opaque film) can protrude beyond the technical edges by at least 0.1 mm and even by at most 5 mm or 2 mm.

The two embodiments with internal masking layer/masking element are not necessarily mutually exclusive, and it is possible to contemplate a masking of the technical edge of the AMOLED screen according to the first embodiment and a masking of the connection element (the connecting part) according to the second, or a double masking of the technical edge of the AMOLED screen or of the connection element according to both embodiments at the same time.

The function of the masking is to hide non-useful and unsightly parts of the device so that only the useful part thereof remains visible from the interior; any method suited to the nature of the substrate according to the first or second embodiment can be employed: printing such as ink jet, silk-screen, enamel as on the face F2 . . . .

The internal masking layer can confine itself to masking the technical edge or edges and a part (at least the visible part) of the electrical connection element (of the connecting part), or even protrude optionally a little by at most 1 to 2 cm. The internal masking layer can be in the zone with the AMOLED screen of width less than or equal to that of the external masking so that the external masking is visible by transparency on either side of the AMOLED screen.

An internal and/or external masking layer can be a dark (black) enamel layer, but more broadly a layer of opaque paint or ink, or a painted polymer layer (e.g. printed PVB), for example polyethylene, polymethyl methacrylate (PMMA).

The external masking layer on face F2 and the internal one on F3 or F4 preferably consist of the same material and even enamel. It is preferred to have an enamel layer at least on face F2 and even on face F4.

In order to limit the warming in the cabin or to limit the use of air conditioning, one of the glazings at least (preferably at least the first glazing) is preferably tinted.

The laminated glazing can comprise a layer which reflects or absorbs solar radiation termed a solar control layer, preferably on face F3 or indeed on face F2 of the second glazing (preferably clear). This electroconducting layer is transparent since it is in part in the clear window region.

The solar control layer can also serve as heating layer with a current infeed at the periphery.

In particular, a heating zone which is connected to at least two electroconducting busbar bars intended for connection to a voltage source in such a way that a current path for a heating current is formed between them.

The width of the busbars is preferably from 2 mm to 30 mm, in a particularly preferred manner from 4 mm to 20 mm and in particular from 10 mm to 20 mm.

A printed busbar preferably contains at least one metal, a metallic alloy, a metallic and/or carbon compound, in particular preferably a noble metal and, in particular, silver. The printing paste preferably contains metallic particles, metallic and/or carbon particles and, in particular particles of noble metal such as silver particles. The thickness of a printed busbar can preferably be from 5 μm to 40 μm, in a particularly preferred manner from 8 μm to 20 μm and more particularly preferably from 8 μm to 12 μm.

As a variant, however, a busbar can also be in the form of a strip of an electrically conducting sheet. The busbar then contains, for example, at least aluminum, copper, tinplated copper, gold, silver, zinc, tungsten and/or tin or alloys of these. The strip preferably has a thickness of 10 μm to 500 μm, in a particularly preferred manner of 30 μm to 300 μm.

The solar control and/or heating layer can comprise a stack of thin layers comprising at least one metallic functional layer such as silver (on F2 or preferably F3). The or each functional layer (silver) is disposed between dielectric layers.

The functional layers preferably contain at least one metal, for example, silver, gold, copper, nickel and chromium, or a metallic alloy. The functional layers in particular preferably contain at least 90% by weight of metal, in particular at least 99.9% by weight of metal. The functional layers can be made of metal for the metallic alloy. The functional layers contain in a particularly preferred manner silver or an alloy containing silver. The thickness of a functional layer (silver etc) is preferably from 5 nm to 50 nm, more preferentially from 8 nm to 25 nm. A dielectric layer contains at least one individual layer made of a dielectric material, for example, containing a nitride such as silicon nitride or an oxide such as aluminum oxide. The dielectric layer can however also contain a plurality of individual layers, for example, individual layers of a dielectric material, layers, smoothing layers, which corresponds to blocking layers and/or antireflection layers. The thickness of a dielectric layer is, for example, from 10 nm to 200 nm. This layer structure is generally obtained through a succession of deposition operations which are performed by a vacuum method such as magnetic cathodic sputtering, supported on-site.

The electroconducting layer is a layer (monolayer or multilayer and therefore stack) preferably of a total thickness of less than or equal to 2 μm, in a particularly preferred manner less than or equal to 1 μm.

The electroconducting layer can have a resistance of 0.4 ohms/square to 10 ohms/square of sheet and even of 0.5 ohms/square to 1 ohm/square, typically with onboard voltages of 12 V to 48 V or, in the case of electric vehicles, with typical onboard voltages of up to 500 V.

It is possible to aggregate electroconducting layer (in silver etc) on face F2 and/or F3. The electroconducting layer on face F3 is for example a stack marketed by the Applicant Company under the name Climacoat. For example, it can be covered directly with a masking of one or more technical edges of the AMOLED screen (detailed previously) and/or of the connecting part.

Alternatively it is possible to use an electroconducting layer on a support, preferably flexible transparent polymeric (polyethylene terephthalate termed PET etc) between the face F2 and F3 (preferably laminated by the interlayer rather than glued) so as to be a solar control, optionally heating, layer (with at least two busbars notably as aforementioned).

Hence, in one embodiment, the glazing (preferably the, notably road, vehicle windshield) comprises between the face F2 and the face F4, notably on the face F3 or on the face F4, a preferably transparent electroconducting layer or a set of electroconducting wires (metallic preferably) that are preferably transparent or invisible. And optionally opposite the display zone, the electroconducting layer is absent (removed, by laser ablation or any other means etc) notably by means of an opening of size greater than or equal to the display zone or the set of electroconducting wires are absent (removed) notably by means of an opening (elimination) of size greater than or equal to the display zone.

The electroconducting wires are advantageously thin, notably of thickness less than or equal to 0.1 mm, in a particularly preferred manner of 0.02 mm to 0.04 mm, and in particular of 0.024 mm to 0.029 mm. The metallic wires preferably contain copper, tungsten, gold, silver or aluminum or alloys of at least two of these metals. The alloys can also contain molybdenum, rhenium, osmium, iridium, palladium or platinum.

The electroconducting layer can cover at least 50% and even at least 70% or 80% or else at least 90% of the main face of the laminated glazing.

The electroconducting layer notably with said opening can be on the face F3 or on a flexible transparent polymeric film on the face F3 side (within the lamination interlayer preferably, closer to the face F3 than the AMOLED screen) and even be a solar control and/or heating layer which covers notably at least 50% and even at least 70% or 80% or else at least 90% of the face F3.

The opening (the absence of the electroconducting layer or electroconducting wires) makes it possible to remove the coloration due to the reflection of the electroconducting layer. It also increases the luminous transmission LT in this zone.

Preferably the second glazing clad with the electroconducting layer (with optional opening, for solar control and/or even heating) is a clear or extraclear glass, such as a Planiclear from the Applicant company (and the first glazing remains tinted).

The present invention will be better understood and other details and advantageous characteristics of the invention will be apparent on reading the examples of laminated vehicle glazings according to the invention and illustrated by the following figures:

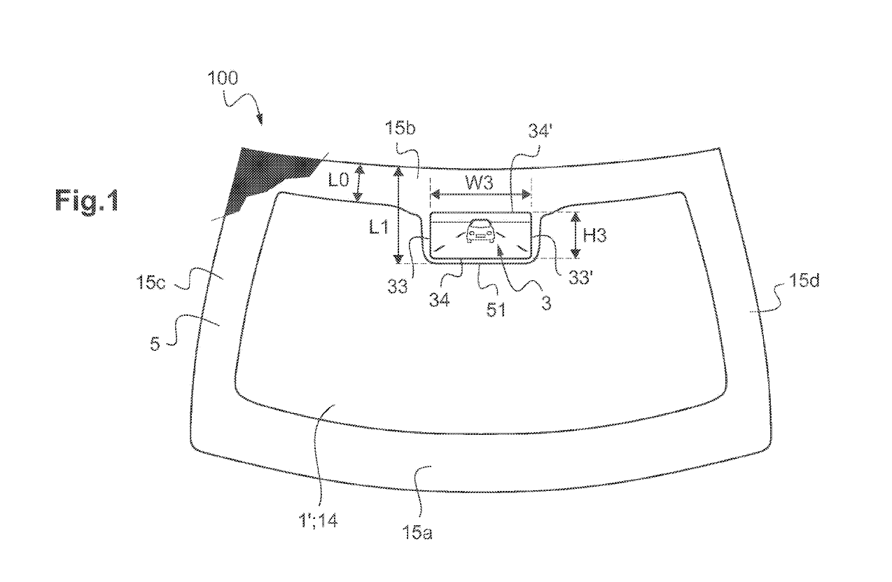

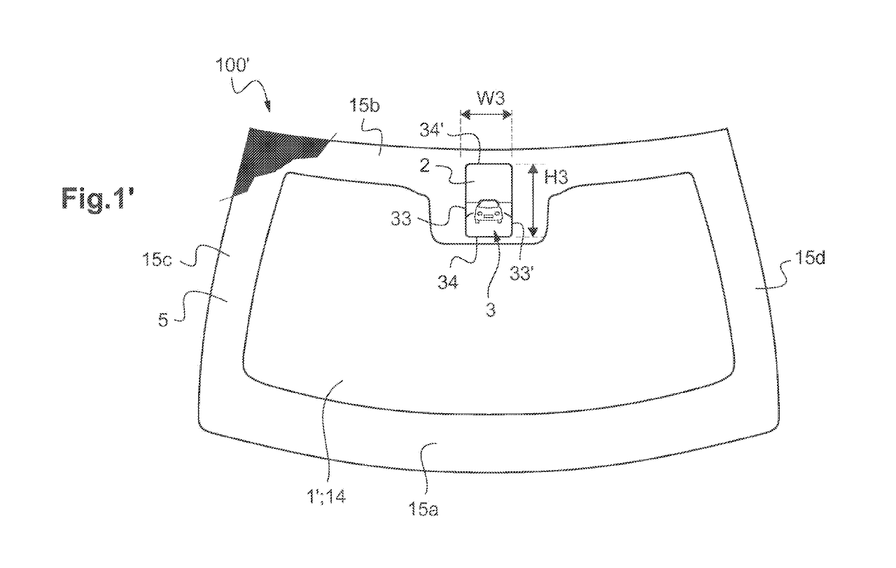

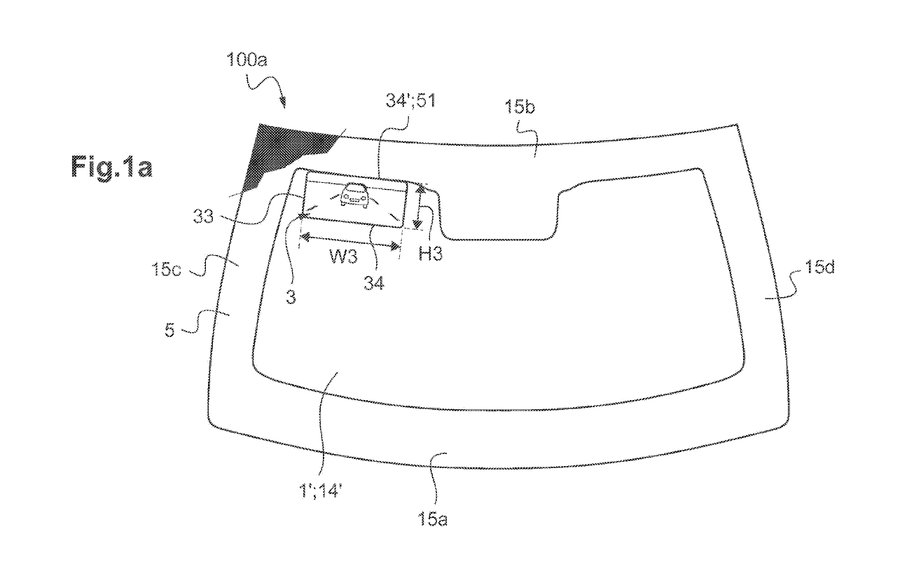

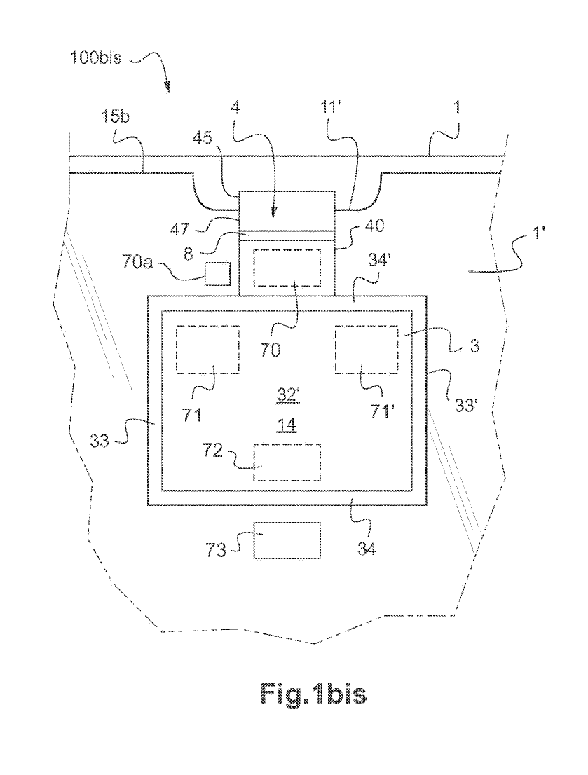

FIGS. 1, 1′, 1a, and 8 are each a face-on schematic view of a windshield with AMOLED screen of an automotive vehicle, inside view

FIGS. 1bis, 1′bis, 2a, 2b are face-on and detail schematic views of a windshield with AMOLED screen of an automotive vehicle, inside view

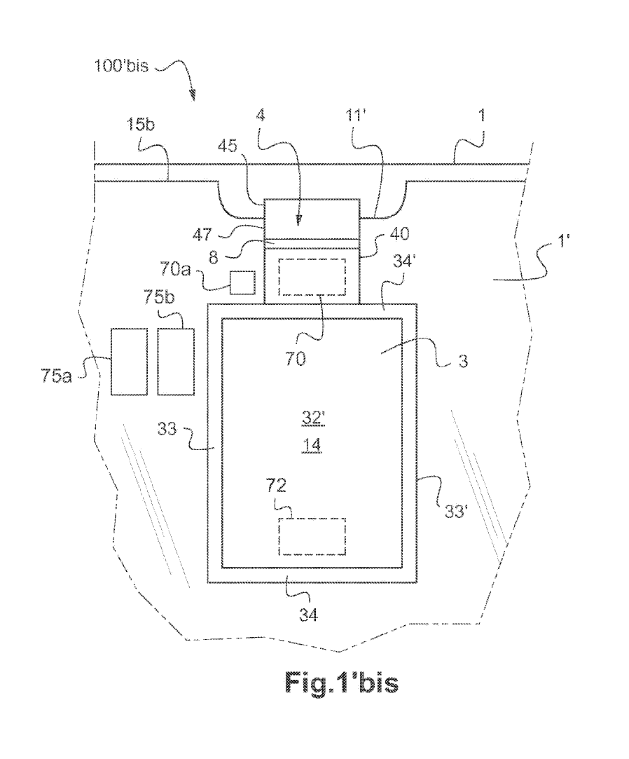

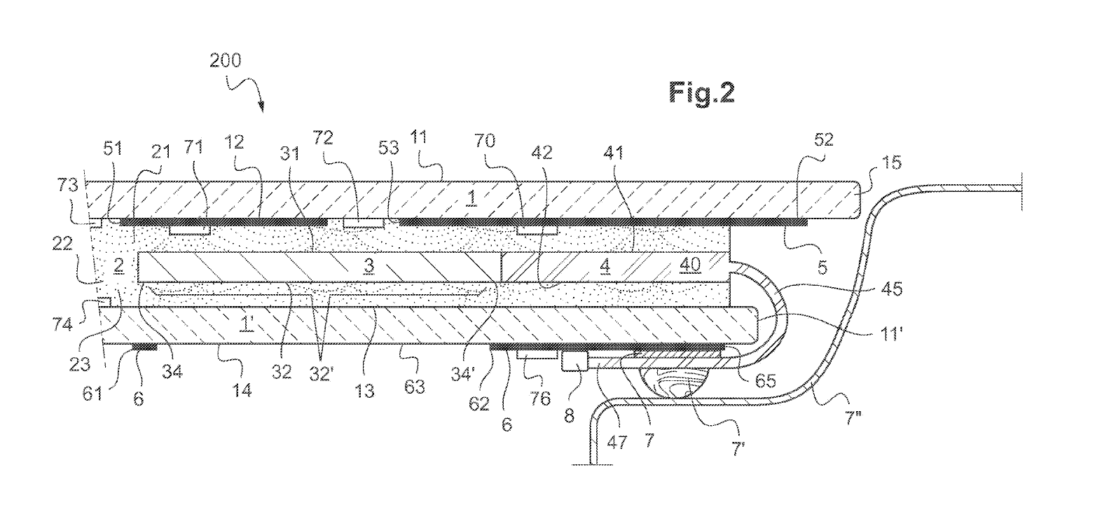

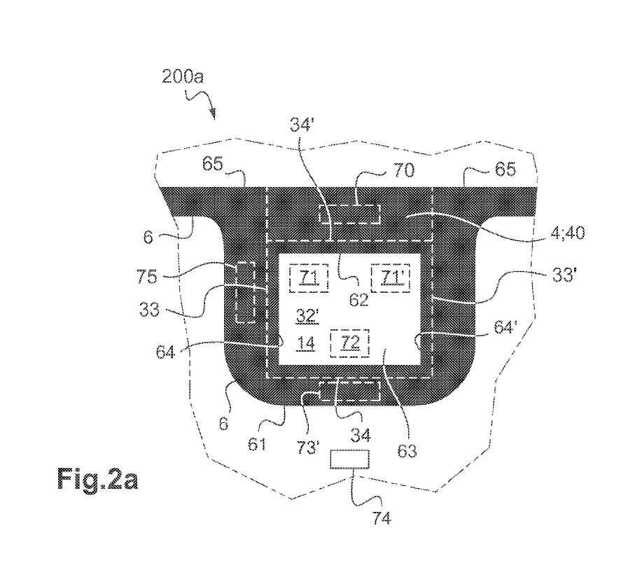

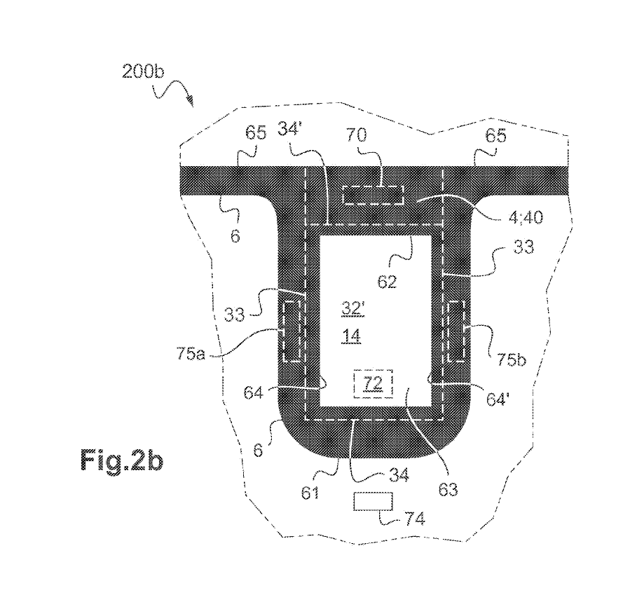

FIGS. 2, 3, 4, 5, 6, 7 are sectional and partial schematic views of a windshield with AMOLED screen of an automotive vehicle, inside view.

It is specified that out of concern for clarity the various elements of the objects represented are not necessarily reproduced to scale. For simplicity, the glazings are not represented cambered nor are the flexible elements in the lamination represented curved while adapting to this or these curvatures (in two dimensions) of glazing.

FIG. 1 is a partial schematic representation viewed from the interior of a windshield with AMOLED screen 100 of an automotive vehicle.

The windshield 100 comprises a clear view central zone (central part of the interior glazing 1′ therefore face F4 side 14) and an external masking peripheral frame 5, bottom 15a and top 15b, left lateral 15c and right lateral 15d longitudinal edges, frame here masking the rear of the opaque or slightly transparent AMOLED screen 3 (not transparent enough to be in the clear window region). The external masking layer 5, on face F2, thus hides from a view of the exterior of the vehicle the AMOLED screen 3 (and its connector not represented here, preferably in the laminate). The function of the enamel 5 is first to hide, viewed from the face F1, the glue bead fastening the final laminated glazing to the bodywork bay.

The AMOLED screen is arranged in a central position of the top longitudinal edge 15b in a horizontal manner and is rectangular. It is (all or part) in a so-called widened zone the width (vertical dimension) L1 of whose enamel is larger than the adjacent width L0 (for example on the left) serving for the conventional and even copilot side masking.

For example, the horizontal dimension or width W3 is at least 120 mm and even up to 250 mm. The vertical dimension or height H3 is at least 75 mm.

Here the AMOLED screen 3 is down at the bottom-most of the widened peripheral zone. Its bottom edge 34 is in proximity to or on the boundary of the enamel flat patch 51 (solid zone) rather than on the boundary of the optional zone with enamel patterns for example at most 15 mm in width. Its top edge 34′ can be as high as possible (to the limit of the zone of vision in the cabin), typically at least 15 mm and better at least 70 mm. This depends on the design of the windshield (size, inclination, clear view desired by the maker).

The edges 53, 53′ of the widened enamel zone 50 can protrude beyond the lateral edges 33 and 33′ for example by at most 2 cm or even 1 or 0.5 cm (limit of the solid zone). In the off state, the AMOLED screen is dark and is even barely if at all distinguishable from the enamel background 5 (protruding over the sides). It is possible to adapt the enamel color accordingly. Preferably the enamel is opaque and dark.

The AMOLED screen is here in a distinct peripheral zone from the transparent central zone termed zone A Z_{A} (the most central and in two parts, quadrilateral-like) or of the restricted zone B Z_{b} (dashed).

A first sensor forming a rain sensor (not visible here) is behind the AMOLED screen within the lamination in the zone swept by a windshield wiper.

On the lit AMOLED screen 3, it is possible to see the central vision of the rear of the vehicle and preferably the lateral visions of the vehicle.

The AMOLED screen can have the rear vision function. It can also have other functions such as: telephone mode, television mode, display of environmental data or data on the road (maps, GPS etc) or on the vehicle, simultaneous display on one or more screen zones (for example in the manner of a mobile telephone screen).

In a variant, not shown, the AMOLED screen is on the drivers side top longitudinal edge. It is higher but can be wider than in the central zone and protrude into the central zone (away from projecting enamel zone).

As a variant, not shown, the AMOLED screen is on the drivers side bottom longitudinal edge in the vision zone. It can be wider than in the central zone.

As a variant, not shown, the AMOLED screen is on the drivers side bottom lateral edge and is arranged vertically as low down as possible in the vision zone.

FIG. 1′ is a partial schematic representation viewed from the interior of a windshield 100′ with AMOLED screen of an automotive vehicle.

The windshield 100′ differs from that in FIG. 1 in that the AMOLED screen is arranged in a vertical manner (H3 larger and W3 smaller). For example H3 is 150 mm to 300 mm and W3 is 60 m to 120 mm.

As a variant, not shown, two AMOLED screens are disposed in this central zone on either side of the AMOLED screen:
for example also arranged in a vertical manner
for example arranged in a horizontal manner

FIG. 1a is a partial schematic representation viewed from the interior of a windshield 100a with AMOLED screen of an automotive vehicle.

The windshield 100a differs from that in FIG. 1 in that the AMOLED screen is arranged in a required transparent zone for example with the top edge 34′ at the limit of the solid zone 51. The first sensor is behind or in the adjacent (widened) central zone.

FIG. 1bis is a face-on and detail schematic view of a windshield 100bis with AMOLED screen of an automotive vehicle, inside view showing different possible positions of sensors.

For simplicity the external masking layer is not represented although it covers the zone of the AMOLED screen (which is peripheral, opaque or slightly transparent). The solid-line elements are seen by transparency through the interior glazing 1′.

As in FIG. 1, the AMOLED screen 3 is arranged horizontally in the central zone of the top longitudinal edge 15b. The windshield 100bis comprises an exterior mineral glass sheet 1 and an interior mineral glass sheet 1′ whose upper edge 15b exhibits a notch 11′.

The AMOLED screen 3 is sandwiched between the exterior glass sheet 1 and the interior glass sheet 1′. It exhibits a display zone 32′ flanked by one or more technical edges (here four) in narrow lateral peripheral 33 and 33′, bottom 34, top 34′ bands generally at least 0.5 mm in width. It is supplied through an electrical connection element 4 of the AMOLED screen 3 which comprises:
a flexible so-called connecting part 40 between the face F2 and the face F3 within the lamination interlayer with a front surface on the face F3 side and a rear surface on the face F2 side, of thickness E4 less than that E2 of the lamination interlayer, linked to the AMOLED screen and extending the AMOLED screen in the direction of the lip of the second glazing,
extended outside of the lip of the second glazing by a flexible so-called exterior part 45, curved and fixed by gluing on face F4 without stretching as far as the display zone 32′ via a part 47 terminated by its connector 8 in a zone accessible at the time of mounting/dismantling.

The connection element 4 is a flexible printed circuit (FPC) suitable for the implementation of 2560×1600 pixels (AMOLED screen). The FPC 4 could also advantageously be of the same width as the AMOLED screen 3, so as to facilitate the insertion of the two elements into the lamination interlayer preferably of polyvinylbutyral (PVB set back a little with respect to the glazing edges). The interior glass 1′ comprises a notch 11′. The dimensions of the notch 11′ are suited to the FPC 4:
width of the notch 11′ greater than or equal to that of the FPC 4;
depth of the notch 11′ greater than or equal to the thickness of the FPC 4 preferably so as to prevent the FPC 4 being visible from the exterior in a case when the edge is evident.

In practice the depth of the notch 11′ lies between 1.5 mm and 2 mm. The zone of the notch 11′ is substantially devoid of lamination interlayer.

Between the face F2 and the rear face of the AMOLED screen 3, it is possible to place sensors notably with conducting layer or electroconducting wires in particular a rain detector 72 for example of capacitive type in the zone of the windshield wiper or else two cameras (stereoscopic vision) 71, 71′ for the visible or the infrared on the face F2, more precisely each glued in an opening (detection area) of an enamel on face F2.

Alternatively or cumulatively, it is possible to place one or more sensors 70 between the face F2 and the rear surface 41 of the FPC, notably on or integrated into the FPC 40 before mounting (and even before shrouding). A predetermined zone is provided on the FPC for this purpose for example by widening the FPC.

Alternatively or cumulatively, it is possible to place one or more sensors 70a alongside the FPC 40, in one and the same plane and of the same thickness preferably and even to use the notch 11′ to afford an exit for a flexible supple support carrying the sensor or sensors 70a.

Alternatively or cumulatively, it is possible to place one or more sensors 73, 75 in proximity to and at the periphery of the AMOLED screen 3 (here left side and below), on the face F2 or on the face F3 or within the lamination in particular any relatively thick element. This or these sensors 73, 75 are masked by the external masking layer (or not, if they are invisible, and then in the clear window region or else in front of the background of the external masking layer with optional opening forming a detection area). This can be cameras or photodiodes.

FIG. 1′bis is a face-on and detail schematic view of a windshield 100′bis with AMOLED screen of an automotive vehicle, inside view. For simplicity the external masking layer is not represented although it covers the zone of the AMOLED screen (peripherally, opaque or slightly transparent). The solid-line elements are seen by transparency through the interior glazing 1′.

It differs from the windshield 100bis by its arrangement vertically.

Between the face F2 and the rear face of the AMOLED screen, it is possible to place sensors notably with conducting layer or electroconducting wires in particular a rain detector 72 in the zone of the windshield wiper, for example of capacitive type.

Alternatively or cumulatively, it is possible to place one or more sensors 70 between the face F3 and the front surface of the FPC, notably on or integrated into the FPC before mounting (and even before shrouding). A predetermined zone is provided on the FPC for this purpose for example by widening the FPC. This sensor can thereafter be masked by an enamel on face F3 or F4 or an opaque overlayer on the FPC 40.

Alternatively or cumulatively, it is possible to place one or more sensors 70a alongside the FPC, in one and the same plane and of the same thickness preferably and even to use the notch 11′ for a flexible supple support carrying sensors 70a. This sensor can thereafter be masked by an enamel on face F3 or F4 or an opaque overlayer on the FPC 40.

Alternatively or cumulatively, it is possible to place one or more sensors 75a, 75b in proximity to and at the periphery of the AMOLED screen, on the face F2 or on the face F3 or within the lamination in particular any relatively thick element masked by the external masking layer (or not, if they are invisible). This can be two cameras (stereoscopic vision) for the visible or the infrared on the face F2 or F3, more precisely each glued in an opening (detection area) of an enamel on face F2.

FIG. 2 is a sectional and partial schematic view of a windshield 200 with AMOLED screen of an automotive vehicle, inside view.

The windshield 200 comprises:
a first glazing 1, with a first main face 11 termed F1, intended to be on the outside of the vehicle, and a second opposite main face 12 termed F2, preferably of thickness E1 of at most 2.5 mm, in particular a preferably tinted soda-lime-silica float glass sheet, with a 2.1 mm thickness of glass such as a TSA glass from the Applicant company
a lamination interlayer of polymeric substance 2, on the face F2 side, of thickness E2 preferably of at least 0.76 mm such as polyvinylbutyral (PVB)
a second glazing 1′, with a third main face 13 termed F3 on the lamination interlayer 2 side and a fourth opposite main face 14 termed F4, intended to be on the inside of the vehicle, preferably of thickness E1 of at most 2.2 mm, in particular a soda-lime-silica float glass sheet with a 1.6 mm thickness of glass, for example tinted such as a TSA glass from the Applicant company,
between the face F2 and the face F3 and within the lamination interlayer, an organic light-emitting diode-based viewing screen, comprising a set of pixels, termed a flexible AMOLED screen 3, the AMOLED screen comprising a zone of dynamic information display 32′, of thickness E3 less than E2 and preferably subcentimetric, AMOLED screen having a front main face 32 oriented toward the face F3 and a rear face 31 oriented toward the face F2, the AMOLED screen is arranged peripherally,
within the lamination interlayer an electrical connection element 4 of the AMOLED screen.

The AMOLED screen 3 is therefore sandwiched between the exterior glass sheet 1 and the interior glass sheet 1′. It exhibits a display zone 32′ flanked by one or more technical edges (one, two, three or four) in narrow peripheral bands 34, 34′ generally at least 0.5 mm in width (and less than 1 cm preferably). The AMOLED screen 3, flexible and extended directly toward an edge of the glazing, by the connection element 4 which is linked to it and extends outside the lamination.

It is supplied through an electrical connection element 4 of the AMOLED screen 3 which comprises:
a flexible so-called connecting part 40 between the face F2 and the face F3 within the lamination interlayer with a front surface 42 on the face F3 side and a rear surface 41 on the face F2 side, of thickness E4 less than that E2 of the lamination interlayer linked to the AMOLED screen and extending the AMOLED screen in the direction of the lip of the second glazing 1′,
extended outside of the lip of the second glazing via a so-called exterior part 45 and curved and fixed by gluing (on face F4 without stretching as far as the display zone 32′ via a part 47 terminated by its connector 8 in a zone accessible at the time of mounting/dismantling.

The connection element 4 is a flexible printed circuit (FPC) suitable for the implementation of 2560×1600 pixels (AMOLED screen). The FPC 4 could advantageously be of the same width as the AMOLED screen 3, so as to facilitate the insertion of the two elements into the lamination interlayer (set back a little with respect to the glazing edges).

The interior glass 1′ comprises a notch 11′. The dimensions of the notch 11′ are suited to the FPC 4:
width of the notch 11′ greater than or equal to that of the FPC 4;
depth of the notch 11′ greater than or equal to the thickness of the FPC 4 preferably so as to prevent the FPC 4 being visible from the exterior in a case when the edge is evident.

In practice the depth of the notch 11′ lies between 1.5 mm and 2 mm. The zone of the notch 11′ is substantially devoid of lamination interlayer.

The AMOLED screen 3 has for example a thickness E3. The connecting part 40 can be less thick. It is optionally covered or shrouded with any material so as to increase (if necessary) the thickness E4 thereof to a value substantially equal to E3. If E4 is equal of 0.4 mm, E3 is from 0.38 to 0.40 mm. A central ply 22 of 0.38 mm is for example used for the lamination, with a reserve to house the AMOLED screen and the connecting part and two external plies 22, 23 of 0.17 mm or 0.38 mm. One of the external plies can be thicker for example 0.76 mm.

It is possible to have more than 3 plies (if insertion of a polymeric film such as a PET etc) or for more mechanical protection.

When the AMOLED screen is at most 0.15 mm or even at most 0.2 mm in thickness, it is optionally possible to eliminate the central ply during assembly.

The first glazing (exterior) 1 comprises an external masking layer 5 on face F2, opaque, of black enamel preferably,
with an edge 51 toward the center of the windshield
and an edge 52 on the lip side of the glazing 15 for example at a distance of at most 3 or 1 mm from the lip 15.

It hides not only the glue bead 7′ of the trim 7″ but also the AMOLED screen 3 (opaque or slightly transparent), the connecting part 40 and the off-glazing part 45 of the FPC and the part 47 and its connector 8.

The external masking layer 5 is preferably a solid zone (a flat patch) rather than a network of patterns. Beyond the edge 51 it can be extended by a network of patterns (made of the same substance) for example in gradation over a width of at most 15 mm and even 5 mm and even larger if the lip 15 is the lower longitudinal edge.

The second glazing 1′ (interior) comprises on face F4 an internal masking layer 6 on face F4 (or as a variant F3), opaque, of black enamel preferably, with
an edge 61 toward the center of the windshield
an edge 65 on the notch side.

This internal masking layer 6 masks from the interior the entire surface of the connecting part 40 in particular that which is in the vision zone (away from zone with trim or optional casing). It can be wider than the connecting part.

This internal masking layer also masks from the interior the technical edges 34, 34′ of the AMOLED screen. It can protrude for example by at most 10 mm opposite the lamination interlayer over the perimeter of the technical edges in order to mask lamination defects.

When the internal masking layer 6 is thus on the perimeter of the AMOLED screen 3, an opening 63 has therefore been formed (masking or post fabrication of the layer) revealing the display zone 32′.

It can also protrude further beyond the technical edges so that its width is (almost equal) to that of the external masking layer 5 on either side of the AMOLED screen (and/or of the connecting part).

The internal masking layer 6 is preferably a solid zone (a flat patch) rather than a network of patterns. Beyond the edge 61 it can be extended by a network of patterns (made of the same substance) for example in gradation over a width of at most 15 mm and even 5 mm and even larger if the lip of the notch 11′ is the lower longitudinal edge. The sensors can be placed preferably in the windshield wiper sweep zone and/or:
on the face F2, behind the AMOLED screen, for example sensor 71 which is capacitive and for example a rain detector and sensor 72 which is a camera opposite a local opening 53 of the masking layer 72
and/or on the face F2, behind the connecting part 40, for example sensor 70 which is which is capacitive and
and/or on the face F2 in a transparent zone (of clear window region), sensor 73 for example a camera, or an optionally transparent sensor if necessary,
and/or on the face F3 in a transparent zone (of clear window region), sensor 74 for example a camera, or an optionally transparent sensor if necessary notably with transparent electroconducting layer or sufficiently fine wire(s).

The sensor 71 or 70 can comprise an electroconducting layer such as a conducting enamel on the enamel on F2.

Power supply conductors for the sensors can exit through the notch 11′ or in proximity. A sensor 76 is on the face F4 in the field of vision, on the enamel 6 on F4, preferably it is in a housing. It serves for example as antenna element for signals used by the AMOLED screen. This can be a conducting enamel on the enamel 6. This can be a transparent or opaque layer under the enamel 6 (no masking housing necessary).

Other sensors for the AMOLED screen can be at the front of the vehicle or in the dashboard.

The sensors notably with layer or with electroconducting wires can be covered with a polymeric film (adhesive-coated) such as a polyimide, a PET or else with a varnish so as to be insulated from the PVB.

A sensor can influence one or more display parameters of the AMOLED screen: luminance, contrast etc as a function of the day or of the night or as a function of the climate (snow, rain, fog). A sensor can serve for a GPS function of the AMOLED screen. The rain detector can be coupled to the AMOLED screen notably to indicate a reduced speed limit (in addition to actuating the windshield wiper or wipers).

A sensor can evaluate the distance to an obstacle or car in front and notably alert the driver regarding too short a safety distance via the AMOLED screen. The camera or cameras in the visible (73 or 74 preferably) also serve to detect fog notably so as to indicate a reduced speed limit via the AMOLED screen.

The camera or cameras in the infrared (73 or 74 preferably) serve at night to alert via the AMOLED screen for example of the presence of animals or of bikes etc

A photodiode serves for example to evaluate the natural illumination so as to adjust the luminance of the AMOLED screen.

A temperature sensor can serve to regulate the operating parameters of the AMOLED screen.

FIG. 2a is a face-on and detail schematic view of a windshield with AMOLED screen of an automotive vehicle, inside view.

It illustrates the possible extent of the internal masking layer 6 on either side of the technical edges 33, 33′, 34, 34′ of the AMOLED screen here arranged horizontally along an upper longitudinal edge, in a central or non-central position.
lateral edges 64 and 64′ protruding preferably by at least 3 mm and
bottom edge 61 protruding preferably by at least 3 mm.

As in FIG. 2, there are:
sensors 70, 71, 71′, 72 (dashed) behind the display zone 32′ of the AMOLED screen or the connecting part 40 of the FPC 4 here of width equal to the AMOLED screen
a sensor 74 on face F3 (or F3) in a transparent zone beyond the edge 61 (and beyond the enamel on face F2).

It is also possible to place one of the sensors behind the internal masking layer 6 (and in front of the external masking layer with a local opening if necessary):
sensor 73′ bottom edge side 61, on the face F3 or F2
sensor 75 lateral edge side (here left) 64, on the face F3 or F2.

Provision may even be made for one or more sensors on the technical edges of the AMOLED screen, optionally sufficiently wide for this purpose.

The internal masking layer 6 is alternatively a strip of given width with an opening for the AMOLED screen,
strip along the upper or lower longitudinal edge, the AMOLED screen arranged horizontally being on the drivers and/or copilot's side
strip along the left or right lateral edge, the AMOLED screen arranged vertically on the drivers and/or copilot's side.

FIG. 2b is a face-on and detail schematic view of a windshield 200b with AMOLED screen of an automotive vehicle, inside view.

It differs from the windshield 200a by its arrangement vertically.

As in FIG. 2, there are:
sensors 72; 70 behind the display zone 32′ of the AMOLED screen or the connecting part 40 of the FPC 4 here of width equal to the AMOLED screen
a sensor 74 on face F3 (or F3) in a transparent zone beyond the edge 61 (and beyond the enamel on face F2).

It is also possible to place one of the sensors behind the internal masking layer 6 (and in front of the external masking layer with a local opening if necessary):
sensor 73′ bottom edge side 61, on the face F3 or F2.

Provision may even be made for one or more sensors on the technical edges of the AMOLED screen, optionally sufficiently wide for this purpose.

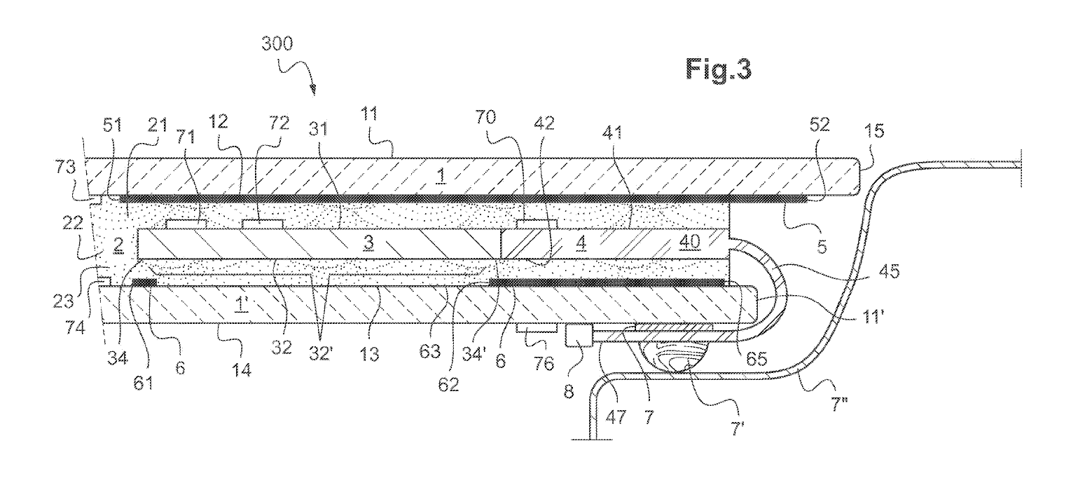

FIG. 3 is a sectional and partial schematic view of a windshield 300 with AMOLED screen of an automotive vehicle, inside view.

The windshield 300 differs from the windshield 200 firstly in that the internal masking layer is on face F3 instead of face F4.

The windshield 300 differs from the windshield 200 also in that the masked sensors 71, 72, 70 on face F2 are henceforth on the rear face 31 or the rear surface 41, for example on a polymeric film such as a PET. The sensor or sensors can comprise in particular an electroconducting layer deposited on the polymeric film with optionally an inserted barrier layer. They can also be covered with a polymeric film (adhesive-coated) such as a polyimide, a PET or else with a varnish so as to be insulated from the PVB.

The sensor 76 can be invisible or quasi-invisible for example comprises a layer of ITO or other conducting transparent oxide.

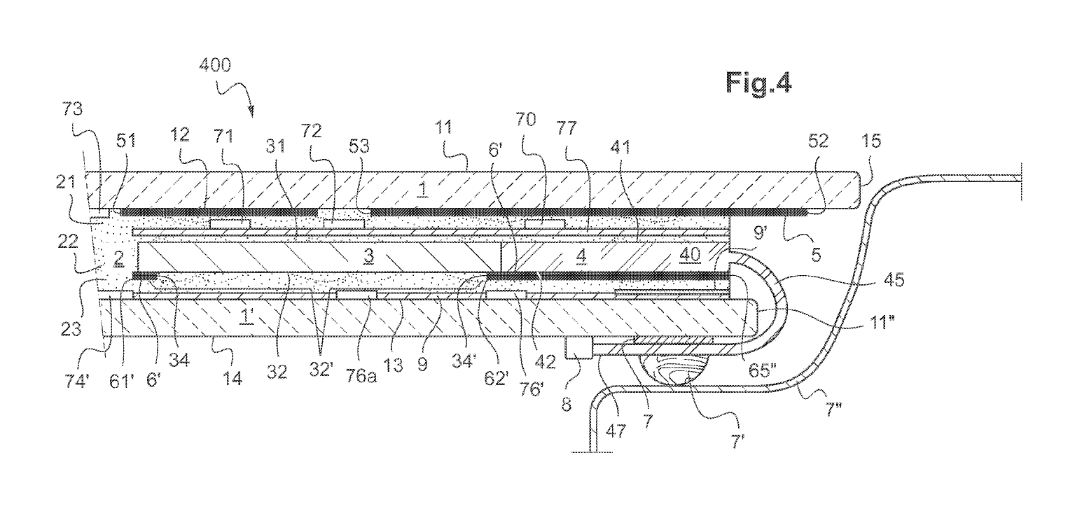

FIG. 4 is a sectional and partial schematic view of a windshield 400 with AMOLED screen of an automotive vehicle, inside view.

It differs from the windshield 200 in that the internal masking layer 6 is replaced with an opaque (opacified) film 6′ of polyethylene terephthalate (PET) that can be stuck to the whole of the AMOLED screen 3 and of the FPC 4 immediately when premounted with a view to its storage, or else form part of a film which has been stuck to this premounted assembly, from which film can then optionally be removed an undesired part precut before assembling the windshield.

The opaque film 6′ constitutes:
a masking of the FPC 40, opaque or slightly transparent, and of the junction between the PVB 22 (central part) and the AMOLED screen 3, which can comprise irregularities and flaws,
as well as a masking 61′, 62′ of the technical edges 34 of the AMOLED screen 3, seen from the interior side of the windshield.

The opaque film 6′ can also be an opacified extension of the transparent polymer material covering the AMOLED screen, that is to say be an integral part thereof.

The opaque film 6′ can also alternatively or cumulatively be an extension of the polymer material covering the FPC, that is to say be an integral part thereof.

Moreover, the face F3 is furnished with an electroconducting layer 9 and optionally with a current infeed 9′ for the latter; this layer can consist of a stack which reflects solar radiation, in silver or other, or with a heating coating/stack furnished for this purpose with its current infeed 9′. It can be covered directly with a masking of the technical edge of the AMOLED screen mentioned previously.

The sensors 71, 72, 70 masked on face F2 are henceforth on a transparent or non-transparent polymeric film 77 such as a PET laminated in the PVB between face F2 and rear surface 31 and rear face 41 and preferably exiting notch side (and even folded back so as to be fixed on face F4. Alternatively this sensor-carrying film (PET) is in the same plane as the AMOLED screen, in proximity and even exits through the notch 11′. The sensor 74′ on the face F2 in the vision zone is a zone of the electroconducting layer 9. For example it forms an antenna element for the exterior (remote-toll-payment etc). Other zones of the electroconducting layer 9 can form a sensor
zone 76a opposite the display zone for example antenna element for the interior
zone 76′ opposite the masked front surface 42 example antenna element for the interior or mist detector.

76a and 76′ are transparent sensors.

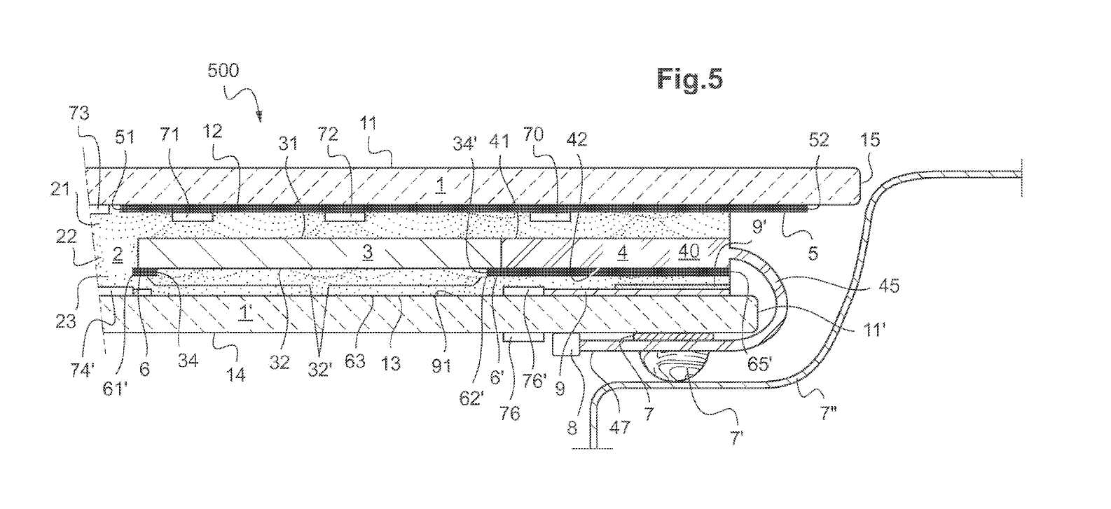

FIG. 5 is a sectional and partial schematic view of a windshield 500 with AMOLED screen of an automotive vehicle, inside view.

It differs from the previous windshield 400 in that for esthetic reasons the electroconducting layer is absent at least in the zone 91 opposite the display zone 32′. For esthetic reasons the electroconducting layer is absent at least in the zone 91 opposite the display zone 9. This opening 91 can be larger (toward the left of the drawing) so as to remove the coloration due to the reflection of the layer. It can also increase the LT in a zone of clear window region (without enamel).

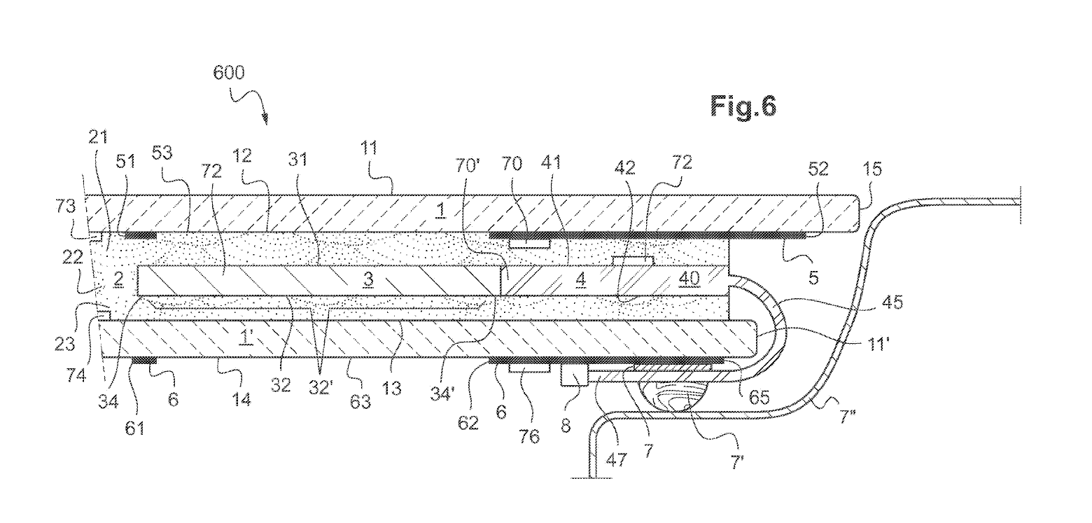

FIG. 6 is a sectional and partial schematic view of a windshield 600 with AMOLED screen of an automotive vehicle, inside view.

It differs from the windshield 200 in that the AMOLED screen 3 is placed in a transparent vision zone of which without external masking layer 6 behind.

However the masking of the exterior of the technical edges 34, 34′ (and even of the PVB 22) by the external enamel layer 5,51 can be accepted. Hence the enamel layer 5 can have an opening 53 facing the AMOLED screen zone. And the masking of the interior of the technical edges 34, 34′ (and even of the PVB 22) by the internal enamel layer 6,61 can be accepted. Hence the enamel layer 6 can have an opening 63 facing the AMOLED screen zone.

The sensors on the face F2 opposite the AMOLED screen zone have been eliminated or are sufficiently transparent. It is possible to add one or more sensors 70, 72′ behind the FPC 4 again masked (fairly transparent with difficulty).

Provision may be made for sensors 71, 70′ integrated into the AMOLED screen or the FPC 40.

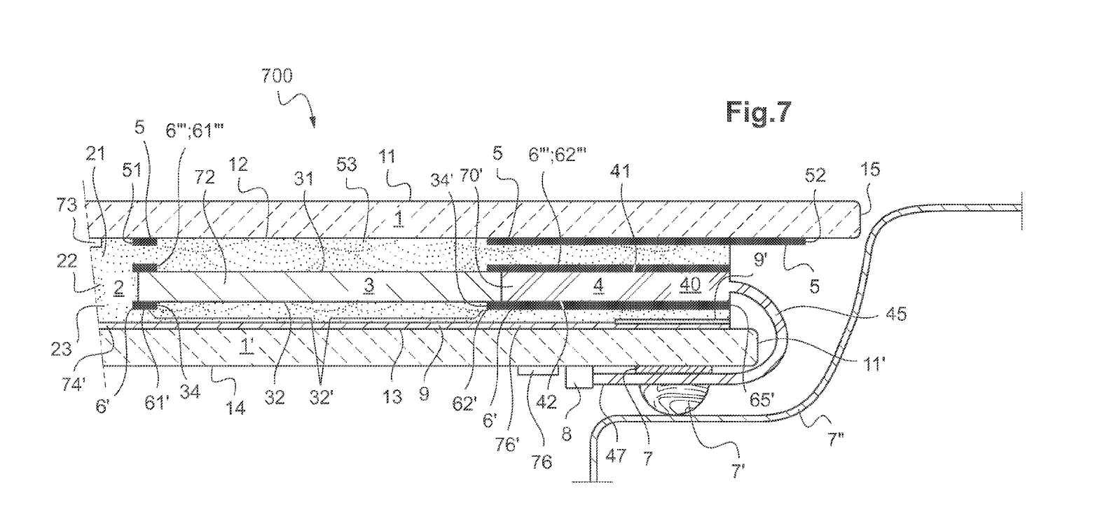

FIG. 7 is a sectional and partial schematic view of a windshield 700 with AMOLED screen of an automotive vehicle, inside view.

It differs from the windshield 600 by the replacement of the internal masking layer 6 by an opaque film 6′ (as in FIG. 5) on the AMOLED screen and the FPC 40 on the front side.

It is also possible an opaque film 6″ (as in FIG. 5) on the AMOLED screen and the FPC 40 on the rear side in addition to or as replacement for the enamel of the edge 51.

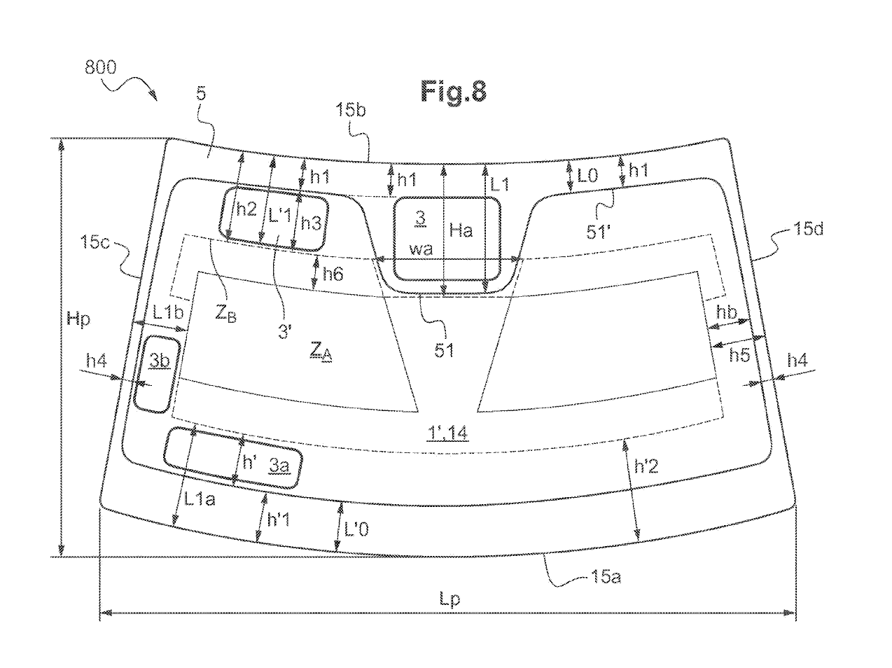

FIG. 8 is a face-on view of a road vehicle windshield which illustrates the possible peripheral zones for an opaque or slightly transparent or even very transparent AMOLED screen 3 (without rear masking) and shows the central transparent zone for a very transparent AMOLED screen 3.

This figure shows distances defining the limits of the vision zone of the driver (or copilot) and of the zone A Z_{A} or of the restricted zone B Z_{B}.

The following pairs of distances are defined:
h1 distance between the upper edge of the windshield and the upper limit F of the peripheral zone of vision of the driver or of the copilot in the vehicle, preferably of at least 15 mm and h2 distance between the upper edge and the upper limit F′ of the central zone of transparency on the driver's or copilot's side, of at least 120 mm, the AMOLED screen 3′ is between said limits F and F′ as well as preferably the optional other AMOLED screen(s) in this zone
h′1 distance between the lower edge of the windshield and the lower limit F1 of the peripheral zone of vision of the driver or of the copilot in the vehicle preferably of at least 40 mm and h′2 distance between the lower edge and the lower limit F′1 of the central transparency zone on the driver's or copilot's side of at least 120 mm, the AMOLED screen 3a is between said limits F1 and F′1 as well as preferably the optional other AMOLED screen(s) in this zone
h4 distance between the lateral edge of the windshield and the lateral limit F2 of the peripheral zone of vision of the driver in the vehicle preferably of at least 15 mm and h5 distance between the lateral edge and the lateral limit F′2 of the central zone of transparency on the drivers side or the copilot's side of at least 80 mm, the AMOLED screen 3b is between said limits F2 and F′2 as well as preferably the optional other AMOLED screen(s) in this zone
h1 distance between the upper edge of the windshield and the upper limit F3 of the peripheral zone of vision of the driver or of the copilot in the vehicle, preferably of at least 15 mm and Hₐ distance between the upper edge and the upper limit F′3 of the central transparency zone in the central part, of at least 180 mm, the AMOLED screen is between said limits F3 and F′3 as well as preferably the optional other AMOLED screen(s) in this zone.

The enamel limits L1, L1, L1a, L1b can be respectively substantially equal to h2, Ha, h′2, h5 when the AMOLED screen has to be masked.

As a variant the AMOLED screen is not masked from the rear (enamel strip less wide) in particular if very transparent.

Preferably the width of the top central zone wa is at most 300 mm.

The (automotive) road vehicle windshield of rectangular shape is:
from 1350 to 1550 mm in width (horizontal dimension) Lp,
from 950 to 1050 mm in height (vertical dimension) Hp.

By way of example we have h1=70 mm; h2=195 mm; h3=125 mm, Ha=270 mm; wa=300 mm; h6=75 mm; h4=25 mm; h5=125 mm; h′=85 mm, hb=100 mm.

1. A laminated vehicle glazing, comprising:
a first glazing, with a first main face, to be oriented on the outside of the vehicle, and a second opposite main face, of thickness E1;
a lamination interlayer of polymeric substance, on the second main face side, of thickness E2;
a second glazing, with a third main face on the lamination interlayer side and a fourth opposite main face, to be oriented on the inside of the vehicle, of thickness E′1, at least one of the first and second glazings being made of mineral glass,
between the second main face and the third main face, an organic light-emitting diode-based viewing screen, comprising a set of pixels, the organic light-emitting diode-based viewing screen comprising a zone of dynamic information display, the organic light-emitting diode-based viewing screen being of thickness E3 less than E2, the organic light-emitting diode-based viewing screen having a front main face oriented toward the third main face and a rear face oriented toward the second main face, the organic light-emitting diode-based viewing screen being covered by a non-zero thickness of lamination interlayer,
wherein the organic light-emitting diode-based viewing screen is flexible and the laminated glazing comprises between the second main face and the third main face a first sensor, of thickness E6 less than E2, covered by a non-zero thickness of lamination interlayer, optionally within the lamination interlayer, the first sensor being arranged according to the following configurations:
(a) between the second main face and the rear face,
(b) in proximity to the organic light-emitting diode-based viewing screen or on a periphery of the organic light-emitting diode-based viewing screen on the front face side,
(c).

2. The laminated vehicle glazing as claimed in claim 1, wherein the organic light-emitting diode-based viewing screen is masked by an external peripheral masking layer between the second main face and the rear face of the organic light-emitting diode-based viewing screen or wherein the organic light-emitting diode-based viewing screen is in a clear window region.

3. The laminated vehicle glazing as claimed in claim 1, wherein the organic light-emitting diode-based viewing screen is opaque or transparent with a luminous transmission LT of less than 10% and
in configuration a) the first sensor is masked from the exterior by said external masking layer, or opposite a detection area corresponding to an opening of the external masking layer,
or in configuration b) the first sensor is masked from the exterior by the organic light-emitting diode-based viewing screen or by the external masking layer,
or in configuration b) in the zone with the first sensor and optionally the organic light-emitting diode-based viewing screen, the luminous transmission of the laminated glazing is at least 70%.

4. The laminated vehicle glazing as claimed in claim 23, wherein the electrical connection element is masked from the exterior by the external masking layer between the rear surface and the second main face.

5. The laminated vehicle glazing as claimed in claim 1, wherein the laminated glazing is a windshield and the first sensor is in a sweep zone of one or more windshield wipers of the windshield.

6. The laminated vehicle glazing as claimed in claim 1, wherein the first sensor or another sensor is a coupling sensor, coupled functionally to the organic light-emitting diode-based viewing screen controlling at least one display parameter and/or image data and optionally on the fourth main face.

7. The laminated vehicle glazing as claimed in claim 1, wherein the first sensor or sensors are chosen from among at least the following sensors: camera in the visible, camera in the infrared, a photodetector, a rain detector, an antenna element for waves coming from the exterior or from the interior.

8. The laminated vehicle glazing as claimed in claim 1, wherein the first sensor is on the second main face, on the external masking layer on the second main face or in a detection area.

9. The laminated vehicle glazing as claimed in claim 1, wherein the first sensor comprises one or more electroconducting wires or else comprises an electroconducting element on a polymeric flexible film.

10. The laminated vehicle glazing as claimed in claim 1, wherein the first sensor comprises a conducting layer at the front or the rear of the organic light-emitting diode-based viewing screen, or a conducting layer on the second main face or the third main face.

11. The laminated vehicle glazing as claimed in claim 23, wherein the second glazing bears on the third main face or the fourth main an internal masking layer configured to mask from the interior:
technical edge or edges of the organic light-emitting diode-based viewing screen and optional other organic light-emitting diode-based viewing screen(s) that is or are adjacent or on distinct longitudinal edges,
and/or the electrical connection element or elements of the organic light-emitting diode-based viewing screen and optional other organic light-emitting diode-based viewing screen(s) that is or are adjacent or on distinct longitudinal edges.

12. The laminated vehicle glazing as claimed in claim 1, wherein technical edge or edges of the organic light-emitting diode-based viewing screen and of optional other organic light-emitting diode-based viewing screen(s) are masked by an interior masking element on the organic light-emitting diode-based viewing screen.

13. The laminated vehicle glazing as claimed in claim 23, wherein the electrical connection element of thickness E4 substantially equal to E2 and of thickness E′4 less than E4 beyond a lip of the second glazing, is curved and is against or fixed by gluing on the fourth main face without stretching as far as the display zone.

14. The laminated vehicle glazing as claimed in claim 23, wherein the organic light-emitting diode-based viewing screen and/or the connecting part has a thickness at most equal to 0.8 mm.

15. The laminated vehicle glazing as claimed in claim 1, comprising on the third main face a conducting layer forming an antenna element and optionally solar control and/or heating layer, which is transparent and opposite the display zone or which is optionally transparent and absent from the zone opposite the front face.

16. The laminated vehicle glazing as claimed in claim 1, comprising between the second main face and the fourth main face, an electroconducting layer or a set of electroconducting wires.

17. The laminated vehicle glazing as claimed in claim 16, wherein the electroconducting layer is on the third main face, or on a flexible transparent polymeric film on the third main face side, and is a solar control and/or heating layer and covers at least 50% of the third main face.

18. The laminated vehicle glazing as claimed in claim 1, wherein the organic light-emitting diode-based viewing screen covers at most an entire peripheral zone visible by the driver in the road vehicle windshield up to an edge of a transparent central vision zone.

19. (canceled)

20. (canceled)

21. The laminated vehicle glazing as claimed in claim 1, wherein the laminated vehicle glazing forms a windshield of a road vehicle, with the first and second glazing cambered.

22. The laminated vehicle glazing as claimed in claim 16, wherein opposite the display zone, the electroconducting layer, or the set of electroconducting wires is absent.

23. A laminated vehicle glazing, comprising:
a first glazing, with a first main face, to be oriented on the outside of the vehicle, and a second opposite main face, of thickness E1;
a lamination interlayer of polymeric substance, on the second main face side, of thickness E2;
a second glazing, with a third main face on the lamination interlayer side and a fourth opposite main face, to be oriented on the inside of the vehicle, of thickness E′1, at least one of the first and second glazings being made of mineral glass,
between the second main face and the third main face, an organic light-emitting diode-based viewing screen, comprising a set of pixels, the organic light-emitting diode-based viewing screen comprising a zone of dynamic information display, the organic light-emitting diode-based viewing screen being of thickness E3 less than E2, the organic light-emitting diode-based viewing screen having a front main face oriented toward the third main face and a rear face oriented toward the second main face, the organic light-emitting diode-based viewing screen being covered by a non-zero thickness of lamination interlayer,
the organic light-emitting diode-based viewing screen including an electrical connection element, with a flexible connecting part between the second main face and the third main face with a front surface on the third main face side and a rear surface on the second main face side, the flexible connecting part covered by a non-zero thickness of lamination interlayer, of thickness E4 less than E2, linked to the organic light-emitting diode-based viewing screen and extending the organic light-emitting diode-based viewing screen in the direction of a lip of the second glazing, the, flexible, electrical connection element extending outside of the lip of the second glazing via an exterior part,
wherein the organic light-emitting diode-based viewing screen is flexible and the laminated glazing comprises between the second main face and the third main face a first sensor, of thickness E6 less than E2, covered by a non-zero thickness of lamination interlayer, optionally within the lamination interlayer, the first sensor being arranged according to the following configurations:
(a) between the second main face and the rear face and/or the rear surface,
(b) in proximity to the organic light-emitting diode-based viewing screen or on a periphery of the organic light-emitting diode-based viewing screen on the front face side,
(c) in proximity to the connecting part or on the connecting part on the front face side.

24. The laminated vehicle glazing as claimed in claim 23, wherein the first sensor comprises a conducting layer at the front or the rear of the organic light-emitting diode-based viewing screen or of the connecting part, or a conducting layer on the second main face or the third main face.

25. The laminated vehicle glazing as claimed in claim 23, wherein technical edge or edges of the organic light-emitting diode-based viewing screen and of optional other organic light-emitting diode-based viewing screen(s) are masked by an interior masking element on the organic light-emitting diode-based viewing screen,
and/or the electrical connection element or elements are masked by said interior masking element or another adjacent one.
